(19) United States
(12) Patent Application Publication
(10) Pub. No.: US 2010/0325952 A1
(43) Pub. Date: Dec. 30, 2010

(54) Systems for roof irrigation, including modular apparatus with sub-irrigation technology, and methods for installation and maintenance of systems

(76) Inventors: James Luke Young, Buckley, IL (US); Andrew Richard Camp, Schaumburg, IL (US)

Correspondence Address: James L. Young, 947 E 700 N Rd., Buckley, IL, 60918, US

(21) Appl. No.: 12/459,206

(22) Filed: Jun. 27, 2009

(51) Int. Cl. A01G 25/00; A01G 9/02; F16K 31/02; B23P 19/00

(52) U.S. Cl. 47/81; 47/48.5; 47/79; 251/129.01; 29/426.2

(57) ABSTRACT

Two designs for rooftop irrigation apparatus are provided. The apparatus employ sub-irrigation and wicking technology to nourish vegetation supported by the apparatus. The apparatus may be placed on outdoor surfaces such as roofs. The first apparatus comprises interlocking modules. The use of sub-irrigation technology enables the modules to sustain a wide variety of plant-life. In addition, the plants may be removed and replaced easily by other plants, including hydroponic plants and vegetables. The second apparatus is a tray that contains an array of wicked protrusions that may hold plant roots and nourish the plants through sub-irrigation. Both apparatus may utilize control systems to control the level of water underneath the vegetation. Excess water may be stored in an auxiliary tank for later use or discharged from the system to decrease apparatus load.

### BACKGROUND OF THE INVENTION

The present invention generally relates to an apparatus for housing vegetation. More particularly, the present invention generally relates to a module that uses sub-irrigation and wicking technology to nourish vegetation that may be displayed on outdoor surfaces.

The concept of green roofs, or roof gardens, traces all the way back to the Hanging Gardens of Babylon in the seventh century B.C. However, green roofs have become more prevalent in the last few decades. Rising concern for the environment, stemming in part from the increasing acceptance of the phenomenon of global warming, has paved the way for increased initiative to use green roofs. Green roofs reduce the urban heat island effect. Urban areas are significantly wanner than surrounding areas because the buildings absorb heat. Green roofs mitigate this problem in two ways. First, the vegetation provides shade that prevents sunlight from reaching and subsequently heating the roof surface. Second, the green roof's vegetation absorbs heat directly from the atmosphere. The heat is used to evaporate water within the plant.

Green roofs also reduce energy losses. The vegetation serves as a layer of insulation that limits heat loss. This is beneficial during cold periods such as winter. In addition, the vegetation may absorb heat and therefore reduce cooling needs during the warmer months. In addition, the ability of a green roof to insulate the underlying roof maintains a more uniform roof temperature throughout the course of a day. Ordinarily, roofs experience thermal cycling. That is, the temperature of the roof varies substantially from day to night. Thermal cycling is known to cause damage to roof integrity. By mitigating thermal cycling, green roofs prolong roof life. Major cities, including Chicago, have sought to take advantage of these benefits and feature green roofs in their cityscapes.

Current green roofing techniques fall under one of two main categories. First, some green roofs are permanent designs that require significant investment. Second, there are also cheaper green roofs that are essentially plastic boxes that house vegetation.

Permanent green roofs are typically composed of several layers, including adhesives, barriers, and retention mats. The layers are constructed on the roof top and ensure that the roof is not damaged by the increased load placed on its surface. These bulky systems are difficult to repair when leaks or other problems arise. They also require an initial commitment to transform a roof so that it may accommodate a green roof.

Conversely, cheap, modular green roof systems are very basic in design. For example, a modular green roof system may comprise plastic structures that house a plant and necessary nutrients. The modules in such a system are often scattered on a roof in a non-uniform manner. As a result of the lack of an overarching design, the system is not aesthetically pleasing. When water is provided to the modules, the water travels downwards through the soil that is housed within the module. As the water travels, it extracts nutrients from the soil. These nutrients are thus leached from the soil and transported to the base of the module where the water collects. As a result of this leaching process, the plant itself is deprived of necessary nutrient. The plant is therefore less healthy. Furthermore, such modules are usually packed fully with nutrient. The modules are therefore heavy and place a large load on the surface on which it is placed. Prior art systems suffer from these drawbacks.

U.S. Pat. No. 6,862,842, (Mischo) discloses a modular green roof system with pre-seeded modular panels. The panels may be filled with soil to sustain the vegetation. However, water travels through the soil from the top surface down towards the bottom and therefore suffers from nutrient leaching that occurs as the water passes down through the system.

U.S. Pat. No. 4,926,586 (Nagamatsu) discloses a module for housing a plant. The invention discloses a box that may accommodate a plant. The box features drainage grooves along its base to aid in draining water. This design does nothing to prevent nutrient leaching.

U.S. Pat. No. 5,673,513 (Casinaty) discloses a turf product. The product is composed of several layers that give the product stability. The product is typical of green roofs that utilize a layered structure to increase life-span. However, these structures are difficult to construct and may not be easily manipulated.

### BRIEF SUMMARY OF THE INVENTION

One or more embodiments of the present invention provide a modular apparatus for an irrigation system. The system is portable and may be installed on outdoor surfaces such as roofs. The apparatus contains piping to control the flow of water on the apparatus. Rather than flowing through vegetation located at the surface of the module, water flows down a water pipe or channel located at the perimeter of the module.

The water collects at the base of the module, where it comes into contact with a wick. The water travels along the length of the wick. The wick is in contact with the soil base that nourishes the vegetation. The soil absorbs water from the wick and the water is then transferred to the plant roots. This sub-irrigation method nourishes vegetation while eliminating the leaching of soil nutrients that occurs when water passes through soil from the top surface. Control systems may be installed to control the water levels within the modules and therefore the weight of the modules. The water level may also be controlled through the use of exit pipes. The modules may be interlocked with one another but may also be removed and added from the apparatus as needed. Within each module, the plant may be easily replaced when desired. The module may sustain plants originally grown outside the module, such as hydroponically grown plants.

One or more embodiments of the present invention provide a tray template that supports vegetation. The tray is portable and may be placed on outdoor surfaces such as roofs. The tray contains vertical protrusions along its length that act as holders. The protrusions house the roots of plants. The interiors of the protrusions are lined with a wick to enable sub-irrigation as with the modular apparatus. Plants may be added or removed from individual holders as desired.

### BRIEF DESCRIPTION OF THE DRAWINGS

FIG. 1 illustrates a modular irrigation apparatus according to an embodiment of the present invention.

FIG. 2 illustrates a flow chart of an embodiment of the sub-irrigation process within the modular irrigation apparatus.

FIG. 3 illustrates a flow chart of an embodiment of the wicking process within the modular irrigation apparatus.

FIG. 4 illustrates a modular irrigation apparatus according to an embodiment of the present invention.

FIG. 5 illustrates a flow chart of an embodiment of the sub-irrigation process within the modular irrigation apparatus.

FIG. 6 illustrates a modular irrigation apparatus according to an embodiment of the present invention.

FIG. 7 illustrates a flow chart of an embodiment of the sub-irrigation process within the modular irrigation apparatus equipped with a control system and storage tank.

FIG. 8 illustrates a block diagram of a control system for a modular irrigation apparatus according to an embodiment of the present invention.

FIG. 9 illustrates a flow chart of an embodiment of the system for controlling the water level within a modular irrigation apparatus equipped with a control system and storage tank.

FIG. 10 illustrates a modular irrigation apparatus according to an embodiment of the present invention.

FIG. 11 illustrates a flow chart of an embodiment of the system for controlling the water level within a modular irrigation apparatus equipped with a control system and exit pipe.

FIG. 12 illustrates a tray apparatus for holding vegetation according to an embodiment of the present invention.

FIG. 13 illustrates a modular irrigation apparatus according to an embodiment of the present invention.

FIG. 14 illustrates a flow chart of a method for installing a roof irrigation system according to an embodiment of the present invention.

FIG. 15 illustrates an array of irrigation modules according to an embodiment of the present invention.

FIG. 16 illustrates a flow chart of a method for maintaining a modular irrigation apparatus according to an embodiment of the present invention.

FIG. 17 illustrates a modular irrigation apparatus according to an embodiment of the present invention.

FIG. 18 illustrates a modular irrigation apparatus according to an embodiment of the present invention.

FIG. 19 illustrates a tray apparatus for holding vegetation according to an embodiment of the present invention.

FIG. 20 illustrates a modular irrigation apparatus according to an embodiment of the present invention.

FIG. 21 illustrates a modular irrigation apparatus according to an embodiment of the present invention.

### DETAILED DESCRIPTION OF THE INVENTION

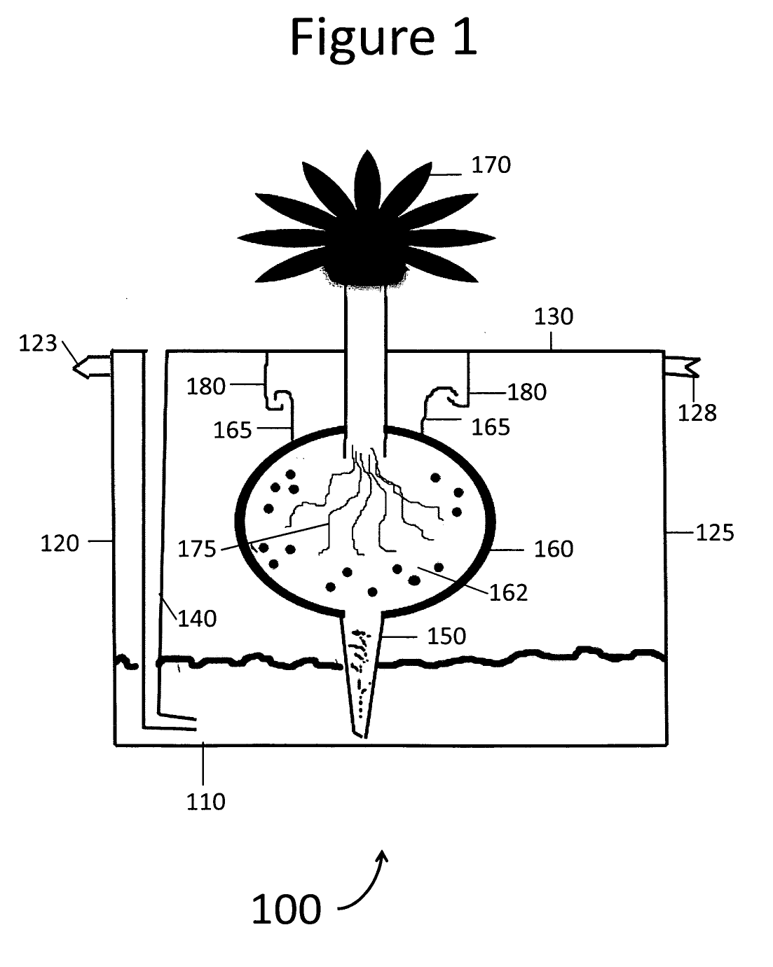

FIG. 1 illustrates a modular apparatus for an irrigation system 100 according to an embodiment of the present invention. The modular apparatus for an irrigation system 100 includes a base floor 110, a left side wall 120, a right side wall 125, a connecting clasp 123, a receiving clasp 128, a top surface 130, a water pipe 140, a wick 150, a nutrient bag 160, a plant 170, and surface hooks 180. The nutrient bag 160 further includes bag hooks 165.

The base floor 110 is adjoined to left side wall 120 along its left edge and is adjoined to right side wall 125 along its right edge. A connecting clasp 123 is affixed to the left side wall 120. A receiving clasp 128 is affixed to the right side wall 125. The top surface 130 intersects with the left side wall 120 and the right side wall 125. The base floor 110, left side wall 120, right side wall 125, and top surface 130 form a water retention chamber, within which water may be stored. The receiving end of the water pipe 140 is located on the top surface 130. The water pipe 140 may be connected to the inside of a side wall 120. The water pipe 140 extends down towards the base floor 110. The delivering end of the water pipe 140 is located slightly above the base floor 110. The tip of the wick 150 rests on the base floor 110. The wick 150 extends vertically from the base floor 110 into the nutrient bag 160. The nutrient bag encases nutrient 162. Bag hooks 165 are attached to the surface of the nutrient bag 160. Surface hooks 180 are attached to the underside of the top surface 130. The bag hooks 165 and the surface hooks 180 are oriented in opposite directions. The bag hooks 165 are oriented in an inverted-J fashion. The surface hooks 180 are oriented in a normal-J fashion. The orientations of the bag hooks 165 and the surface hooks 180 allow the hooks to link together. The ends of the bag hooks 165 rest on the ends of the surface hooks 180. The roots 175 of the plant 170 are embedded in the nutrient 162. The trunk of the plant 170 extends vertically from within the nutrient 162 through an aperture in the top surface 130. The vegetation of the plant 170 is situated above the top surface 130.

The vegetation of the plant 170 receives light from an external light source such as the sun. The vegetation of the plant 170 is also visible to observers of the modular apparatus for an irrigation system 100. Water from an external source such as the atmosphere descends onto the top surface 130 and the vegetation of the plant 170. The top surface 130 is impermeable. The water rests on the top surface 130 and flows down the water pipe 140. The water exits the water pipe 140 and collects on the base floor 110. The wick 150 absorbs water that has collected on the base floor 110. The wick 150 continues to absorb water from the base floor 110 until the wick 150 is saturated. The water within the wick 150 travels upwards along the wick 150 until it reaches the interface between the top end of the wick 150 and the nutrient 162. The nutrient 162 absorbs water from the wick 150. The water percolates through the nutrient 162 and reaches the interface between the roots 175 and the nutrient 162. The roots 175 then absorb water from the nutrient 162. The modular apparatus for an irrigation system 100 thus houses a plant that is nourished with light, nutrient, and water. The water is provided to the plant through sub-irrigation and wicking technology.

In an embodiment of the present invention, there is a plurality of apertures on the top surface 130. Plants 170 may be placed through each of these apertures. In an alternative embodiment of the present invention, the water may travel down towards the base floor 110 via a channel rather than the water pipe 140. In this embodiment, there remains an aperture on the top surface where the receiving end of the water pipe 140 is ordinarily situated. The water pipe 140 is replaced by a chute that guides the water down towards the base floor 110. Alternatively, there may be neither a water pipe 140 nor a chute. The water enters an aperture located on the top surface 130 where the receiving end of the water pipe 140 is ordinarily situated. The water then drops directly onto the base floor 110.

The connecting clasp 123 may connect with the receiving clasp 128 of a second modular apparatus for an irrigation system 100. Several modular apparatuses for an irrigation system 100 may be connected together in this way.

In one embodiment of the modular apparatus for an irrigation system 100, the left side wall 120 and right side wall 125 are made of plastic. Alternatively, the left side wall 120 and right side wall 125 may be made of a biodegradable material. The nutrient 162 is preferably soil. The nutrient 162 may also contain fertilizer. The water pipe 140 may be made of various materials such as plastic or metal. The plant 170 may be a small tree, bush, or vegetable. The top surface 130 may be constructed so that it is parallel to the surface on which the modular apparatus for an irrigation system 100 rests. Alternatively, the top surface 130 may be slanted relative to the resting surface so that water on the top surface 130 travels more quickly to the opening of the water pipe 140.

In an alternative embodiment of the present invention, there is a plurality of wicks 150. There may also be a plurality of water pipes 140. The base floor 110, left side wall 120, right side wall 125, and top surface 130 may be adjoined so as to form a cube. Alternatively, the base floor 110, left side wall 120, right side wall 125, and top surface 130 may form a three-dimensional rectangle, trapezoid or other shape. The base floor 110, left side wall 120, right side wall 125, and top surface 130 may also be curved so that the modular apparatus 100 is spherical.

The use of the connecting clasp 123 and the receiving clasp 128 to interconnect modular apparatuses for an irrigation system 100 may be replaced by various alternative connecting mechanisms. For example, the left side wall 120 and right side wall 125 may feature grooves along their surfaces that allow modules to fit together. Alternatively, the left side wall 120 and right side wall 125 may contain lips along their edges that would enable the modules to hook together.

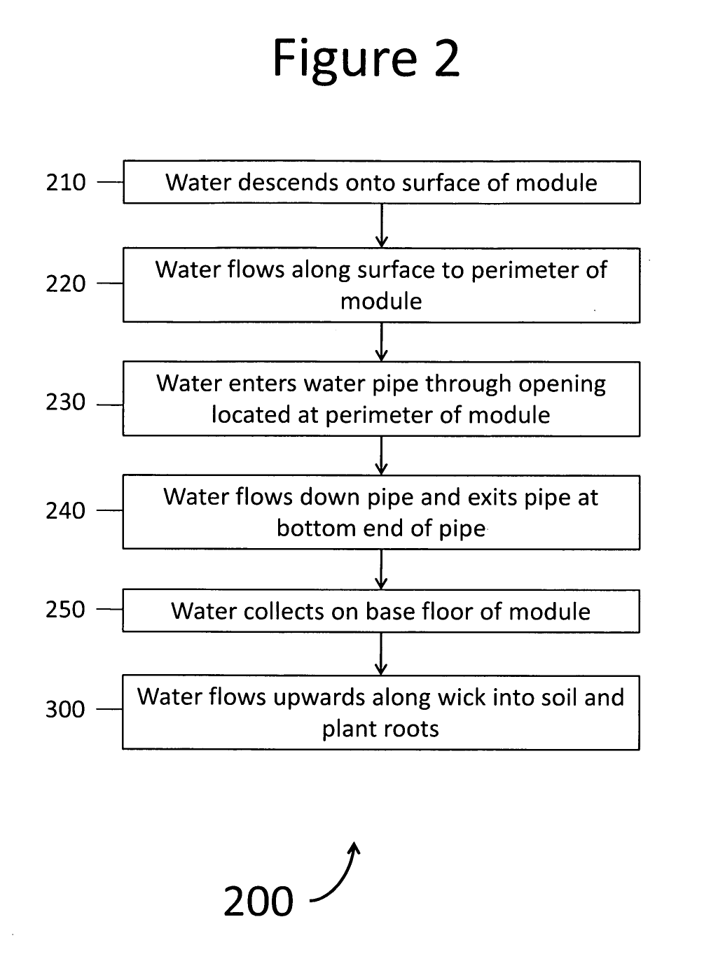

FIG. 2 illustrates a method for irrigating water 200 within a modular apparatus for an irrigation system 100 according to an embodiment of the present invention. First, in step 210, water descends onto the top surface of the module 130. The water may be intentionally sprayed onto the surface 130 by a watering can. Alternatively, the water may arrive naturally in the form of rainfall. The water then flows along the top surface 130 towards the perimeter of the surface 220. The top surface 130 may be slanted and therefore the water would flow towards the perimeter under the force of gravity. The water flow may alternatively result from the drag caused by water flowing down through the water pipe 140. As the water reaches the perimeter of the module, it enters the water pipe 140 through the pipe opening located at the module perimeter 230. The water then flows down the pipe 140 and exits at the bottom of end of the pipe 240. As the water flows out of the water pipe 140, it collects on the base floor 110 of the module. In the final step, 300, the water flows upwards along a wick 150 into the nutrient 162 and plant roots 175.

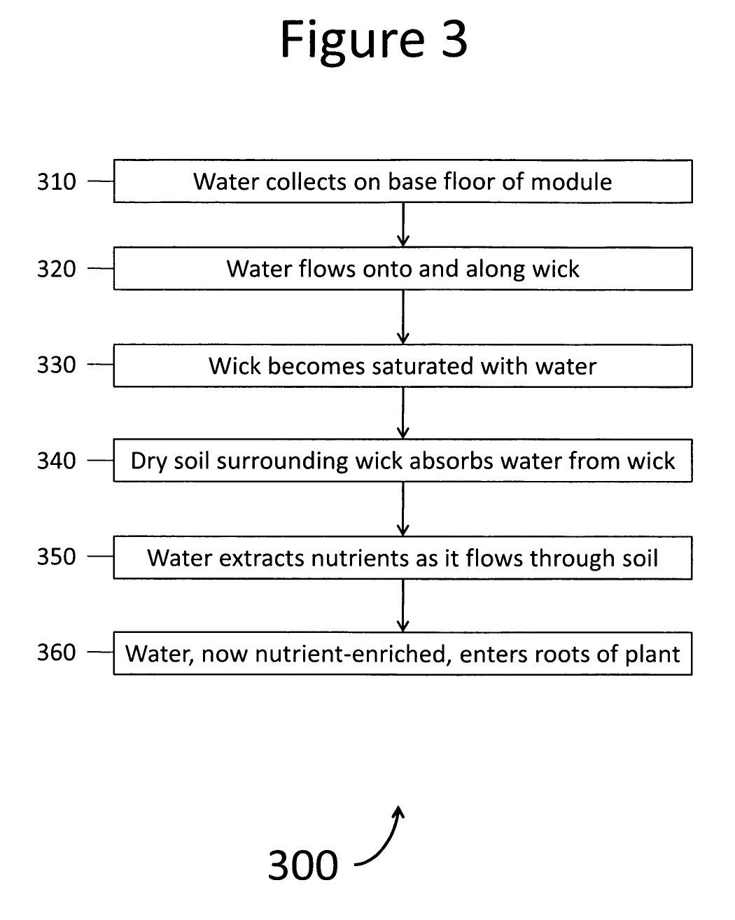

FIG. 3 illustrates a method for delivering water to the roots of a plant within a module via a wick 300. Initially, water collects on the base floor of the module 310. The wick is in contact with the base floor of the module and therefore is in contact with any water that has collected on the base floor. The wick absorbs water, which then travels along the wick 320. The wick continues to absorb water until it becomes saturated 330. The wick extends into a bed of soil. At the interface between the soil and the wick, water is transferred from the wick to the soil 340. The soil continues to absorb water until it is saturated. The water then travels throughout the soil as dry regions of the soil absorb water from wetter regions of the soil. As the water travels through the soil, it extracts nutrients from the soil 350. The roots of the plant are embedded in the soil. The roots of the plant absorb water from the soil at the interface between the roots and the soil 360. Water has thus traveled from the surface of the module to the roots of the plant. The nutrients of the soil are carried to the roots of the plant. The upward movement of the water prevents the leaching of soil nutrients that would occur if the water passed downwards through the soil.

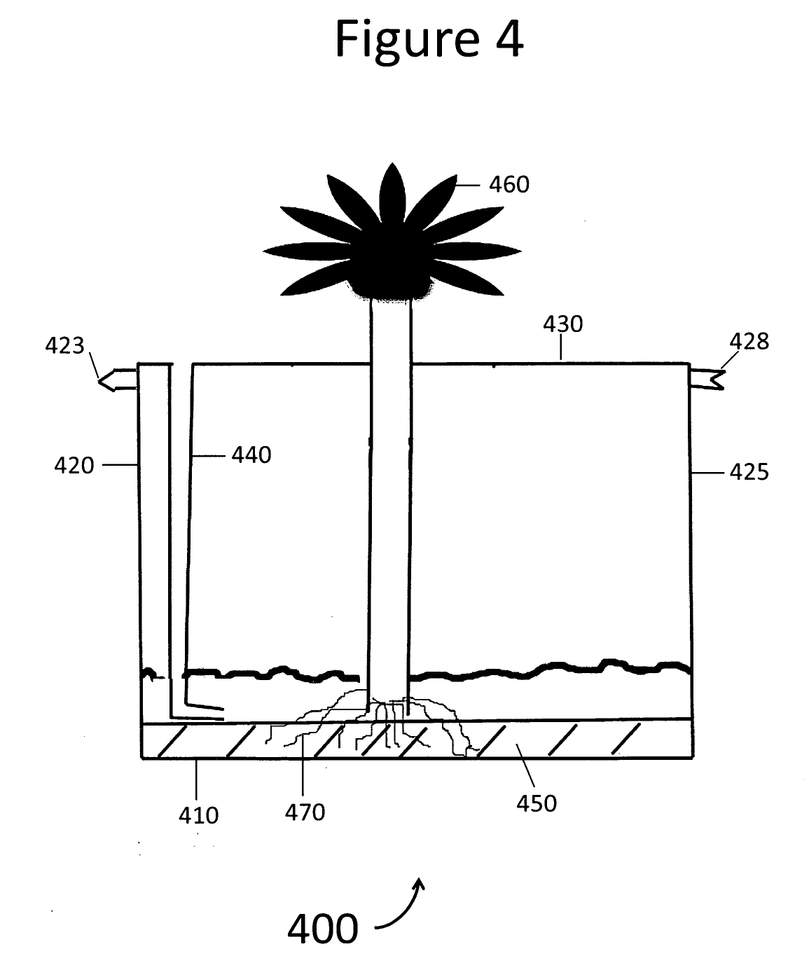

FIG. 4 illustrates a modular apparatus for an irrigation system 400 according to an embodiment of the present invention. The modular apparatus for an irrigation system 400 includes a base floor 410, a left side wall 420, a right side wall 425, a connecting clasp 423, a receiving clasp 428, a top surface 430, a water pipe 440, a nutrient layer 450, a plant 460, and the roots of the plant 470.

The base floor 410 is adjoined to left side wall 420 along its left edge and is adjoined to right side wall 425 along its right edge. A connecting clasp 423 is affixed to the left side wall 420. A receiving clasp 428 is affixed to the right side wall 425. The top surface 430 intersects with the left side wall 420 and the right side wall 425. The base floor 410, left side wall 420, right side wall 425, and top surface 430 form a water retention chamber, within which water may be stored. The receiving end of the water pipe 440 is located on the top surface 430. The water pipe 440 may be connected to the inside of the left side wall 420. The water pipe 440 extends down towards the base floor 410. The delivering end of the water pipe 440 is located slightly above the nutrient layer 450. The nutrient layer 450 rests on the base floor 410. The roots 470 of the plant 460 are embedded in the nutrient layer 450. The trunk of the plant 460 extends vertically from within the nutrient layer 450 through an aperture in the top surface 430. The vegetation of the plant 460 is situated above the top surface 430.

The vegetation of the plant 460 receives light from an external light source such as the sun. The vegetation of the plant 460 is also visible to observers of the modular apparatus for an irrigation system 400. Water from an external source such as the atmosphere descends onto the top surface 430 and the vegetation of the plant 460. The top surface 430 is impermeable. The water rests on the top surface 430 and flows down the water pipe 440. The water exits the water pipe 440 and flows onto the nutrient layer 450. The water flows down through the nutrient layer 450. As the water percolates through the nutrient layer 450, it extracts nutrient from the soil. The plant roots 470 absorb water from the nutrient layer 450.

If the nutrient layer 450 is saturated with water, water flowing out from the water pipe 440 collects at the surface of nutrient layer 450. The water does not flow down through the soil until the soil is no longer saturated. Water resting on the nutrient layer 450 gradually evaporates. Some of the water vapor is absorbed by the trunk of the plant 460.

In an embodiment of the present invention, there is a plurality of apertures on the top surface 430. Plants 460 may be placed through each of these apertures. In an alternative embodiment of the present invention, the water may travel down towards the base floor 410 via a channel rather than the water pipe 440. In this embodiment, there remains an aperture on the top surface where the receiving end of the water pipe 440 is ordinarily situated. The water pipe 440 is replaced by a chute that guides the water down towards the base floor 410. Alternatively, there may be neither a water pipe 440 nor a chute. The water enters an aperture located on the top surface 430 where the receiving end of the water pipe 440 is ordinarily situated. The water then drops directly onto the base floor 410.

The connecting clasp 423 may connect with the receiving clasp 428 of a second modular apparatus for an irrigation system 400. Several modular apparatuses for an irrigation system 400 may be connected together in this way.

In one embodiment of the modular apparatus for an irrigation system 400, the left side wall 420 and right side wall 425 are made of plastic. Alternatively, the left side wall 420 and right side wall 425 may be made of a biodegradable material. The nutrient layer 450 is preferably soil. The nutrient layer 450 may also contain fertilizer. The water pipe 440 may be made of various materials such as plastic or metal. The plant 470 may be a small tree, bush, or vegetable. The top surface 430 may be constructed so that it is parallel to the surface on which the modular apparatus for an irrigation system 400 rests. Alternatively, the top surface 430 may be slanted relative to the resting surface so that water on the top surface 430 travels more quickly to the opening of the water pipe 440.

In an alternative embodiment of the present invention, there is a plurality of water pipes 440. The base floor 410, left side wall 420, right side wall 425, and top surface 430 may be adjoined so as to form a cube. Alternatively, the base floor 410, left side wall 420, right side wall 425, and top surface 430 may form a three-dimensional rectangle, trapezoid or other shape. The base floor 410, left side wall 420, right side wall 425, and top surface 430 may also be curved so that the modular apparatus 400 is spherical.

The use of the connecting clasp 423 and the receiving clasp 428 to interconnect modular apparatuses for an irrigation system 400 may be replaced by various alternative connecting mechanisms. For example, the left side wall 420 and right side wall 425 may feature grooves along their surfaces that allow modules to fit together. Alternatively, the left side wall 420 and right side wall 425 may contain lips along their edges that would enable the modules to hook together.

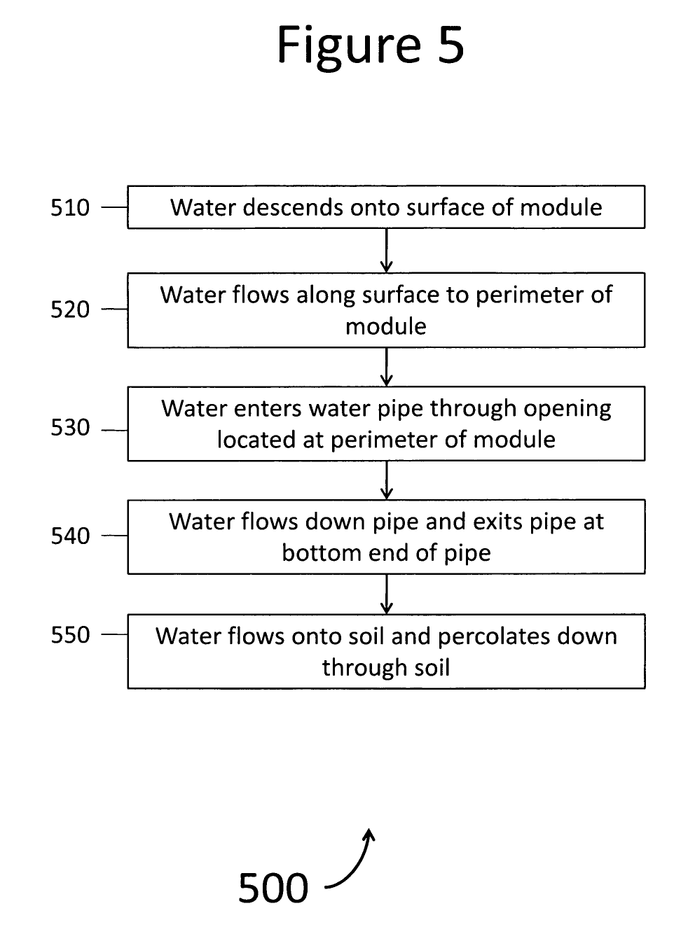

FIG. 5 illustrates a method for irrigating water 500 within a modular apparatus for an irrigation system 400 according to an embodiment of the present invention. First, in step 510, water descends onto the top surface of the module 430. The water may be intentionally sprayed onto the surface 430 by a watering can. Alternatively, the water may arrive naturally in the form of rainfall. The water then flows along the top surface 430 towards the perimeter of the surface 520. The top surface 430 may be slanted and therefore the water would flow towards the perimeter under the force of gravity. The water flow may alternatively result from the drag caused by water flowing down through the water pipe 440. As the water reaches the perimeter of the module, it enters the water pipe 440 through the pipe opening located at the module perimeter 530. The water then flows down the pipe 440 and exits at the bottom of end of the pipe 540. As the water exits the water pipe 440, it flows onto the nutrient layer 450. In the final step, 550, the water travels down through the soil under the force of gravity. The plant roots 470 absorb water from the nutrient layer 450 at the interface between the nutrient layer 450 and the plant roots 470.

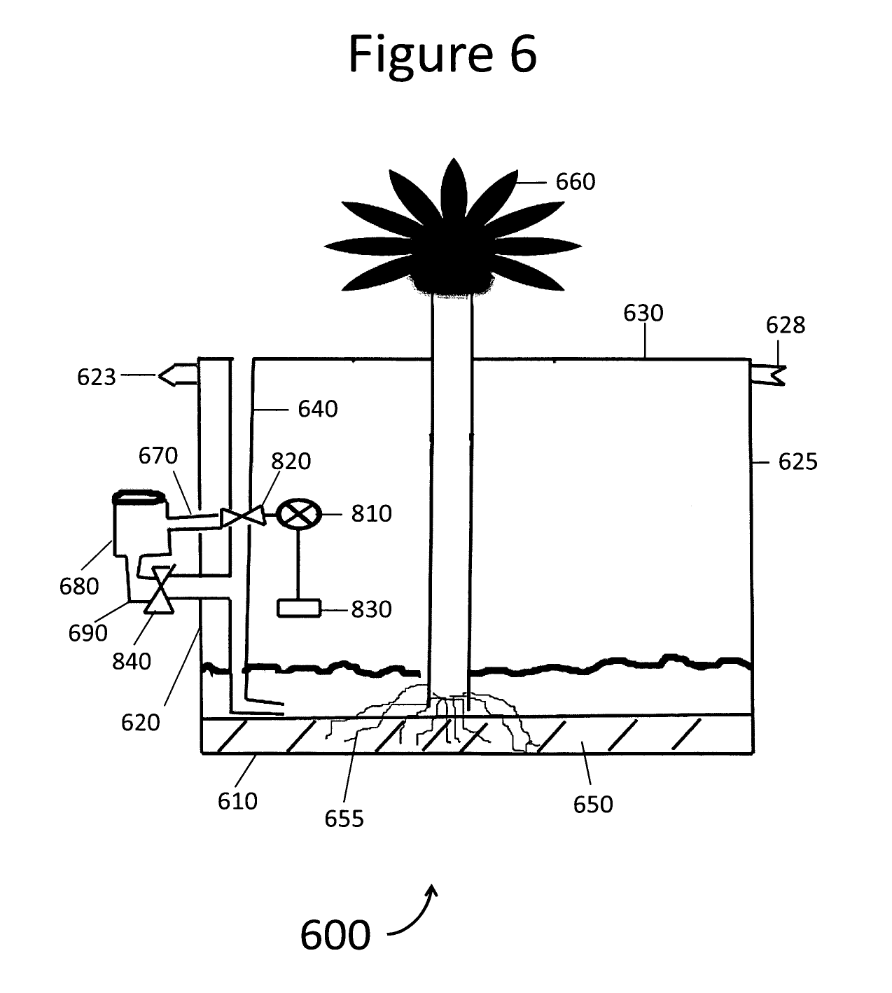

FIG. 6 illustrates a modular apparatus for an irrigation system 600 according to an embodiment of the present invention. The modular apparatus for an irrigation system 600 includes a base floor 610, a left side wall 620, a right side wall 625, a connecting latch 623, a receiving latch 628, a top surface 630, a water pipe 640, a nutrient layer 650, a plant 660, a tank inlet pipe 670, a storage tank 680, a tank outlet pipe 690, a water level controller 810, a control valve 820, a water level measurement device 830, and a tank outlet valve 840.

The base floor 610 is adjoined to left side wall 620 along its left edge and is adjoined to right side wall 625 along its right edge. A connecting clasp 623 is affixed to the left side wall 620. A receiving clasp 628 is affixed to the right side wall 625. The top surface 630 intersects with the left side wall 620 and the right side wall 625. The base floor 610, left side wall 620, right side wall 625, and top surface 630 form a water retention chamber, within which water may be stored. The receiving end of the water pipe 640 is located on the top surface 630. The water pipe 640 may be connected to the inside of the left side wall 620. The water pipe 640 extends down towards the base floor 610. The delivering end of the water pipe 640 is located slightly above the nutrient layer 650. The nutrient layer 650 rests on the base floor 610. The roots 655 of the plant 660 are embedded in the nutrient layer 650. The trunk of the plant 660 extends vertically from within the nutrient layer 650 through an aperture in the top surface 630. The vegetation of the plant 660 is situated above the top surface 630.

The water pipe 640 is installed with a control valve 820 at a point towards the middle of the pipe 640. The control valve 820 is in electronic communication with the water level controller 810. The water level controller 810 is in electronic communication with the water level sensor 830. The tank inlet pipe 670 is connected to the control valve 820. The tank inlet pipe 670 feeds into the storage tank 680. The tank outlet pipe 690 is connected to the base of the storage tank 680. The tank outlet valve 840 is installed on the tank outlet pipe 690. The tank outlet valve 840 is in electronic communication with the water level controller 810. The tank outlet pipe 690 is connected to the water pipe 640.

The vegetation of the plant 660 receives light from an external light source such as the sun. The vegetation of the plant 660 is also visible to observers of the modular apparatus for an irrigation system 600. Water from an external source such as the atmosphere descends onto the top surface 630 and the vegetation of the plant 660. The top surface 630 is impermeable. The water rests on the top surface 630 and flows down the water pipe 640. The water flowing down the water pipe 640 reaches the water control valve 820.

The water level sensor 830 measures the level of water resting on the nutrient layer 650. The water level sensor 830 sends the data representing the water level to the water level controller 810. The water level controller 810 manipulates the control valve 820 so that water flows either through the tank inlet pipe 670 or continues down the water pipe 640. This determination is made by the water level controller 810 in accordance with the method for controlling water flow in a modular apparatus 900, as described later.

If the water level controller 810 manipulates the control valve 820 so that water flows down the water pipe 640, the water exits the water pipe 640 and flows onto the nutrient layer 650. The water flows down through the nutrient layer 650. As the water percolates through the nutrient layer 650, it extracts nutrient from the soil. The plant roots 655 absorb water from the nutrient layer 650.

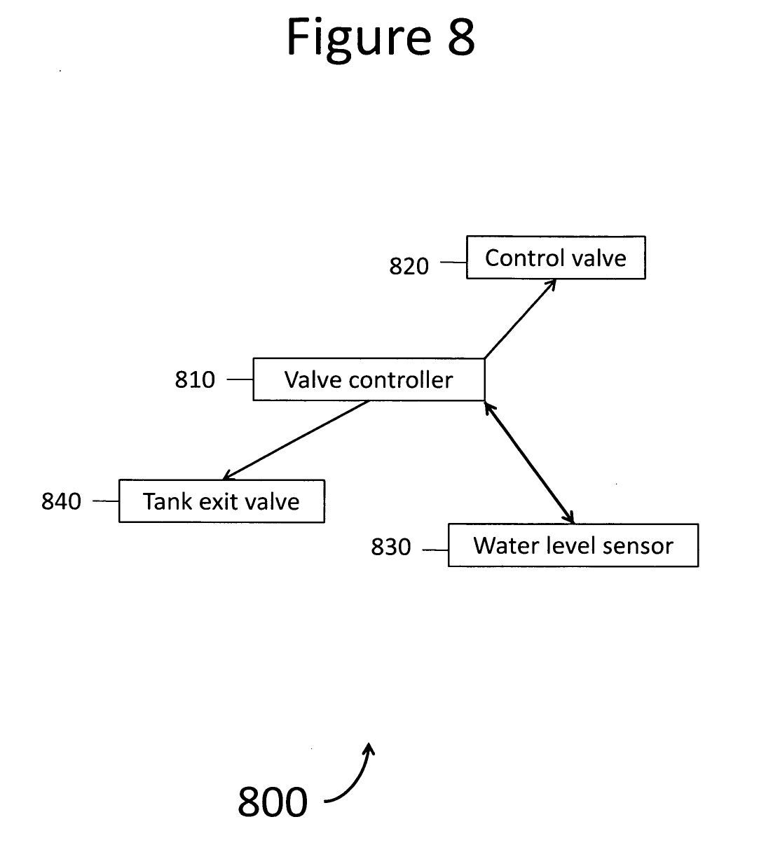

If the water level controller 810 manipulates the control valve 820 so that water flows through the tank inlet pipe 670, the water flows into the storage tank 680. The water collects in the storage tank 680. The water level controller 810 further decides whether to open the tank outlet valve 840 to send water from the storage tank 680 to the water pipe 640 through the tank outlet pipe 690. This decision is also made in accordance with the method for controlling water flow in a modular apparatus 900, as described later. The control system setup between the valve controller 810, the control valve 820, the water level sensor 830, and the tank exit valve 840 is explained further in FIG. 8. The water level within the modular apparatus is thus regulated and kept below a maximum desired level. Excess water is stored and may be fed to the plant as necessary at a later time.

In an embodiment of the present invention, there is a plurality of apertures on the top surface 630. Plants 660 may be placed through each of these apertures.

The connecting clasp 623 may connect with the receiving clasp 628 of a second modular apparatus for an irrigation system 600. Several modular apparatuses for an irrigation system 600 may be connected together in this way.

In one embodiment of the modular apparatus for an irrigation system 600, the left side wall 620 and right side wall 625 are made of plastic. Alternatively, the left side wall 620 and right side wall 625 may be made of a biodegradable material. The nutrient layer 650 is preferably soil. The nutrient layer 650 may also contain fertilizer. The water pipe 640 may be made of various materials such as plastic or metal. The plant 660 may be a small tree, bush, or vegetable. The top surface 630 may be constructed so that it is parallel to the surface on which the modular apparatus for an irrigation system 600 rests. Alternatively, the top surface 630 may be slanted relative to the resting surface so that water on the top surface 630 travels more quickly to the opening of the water pipe 640. In a particular embodiment of the modular apparatus for an irrigation system 600, the storage tank 680 is made of plastic. The tank may alternatively be made of stainless steel.

In an alternative embodiment of the present invention, there is a plurality of water pipes 640. The base floor 610, left side wall 620, right side wall 625, and top surface 630 may be adjoined so as to form a cube. Alternatively, the base floor 610, left side wall 620, right side wall 625, and top surface 630 may form a three-dimensional rectangle, trapezoid or other shape. The base floor 610, left side wall 620, right side wall 625, and top surface 630 may also be curved so that the modular apparatus 600 is spherical.

The use of the connecting clasp 623 and the receiving clasp 628 to interconnect modular apparatuses for an irrigation system 600 may be replaced by various alternative connecting mechanisms. For example, the left side wall 620 and right side wall 625 may feature grooves along their surfaces that allow modules to fit together. Alternatively, the left side wall 620 and right side wall 625 may contain lips along their edges that would enable the modules to hook together.

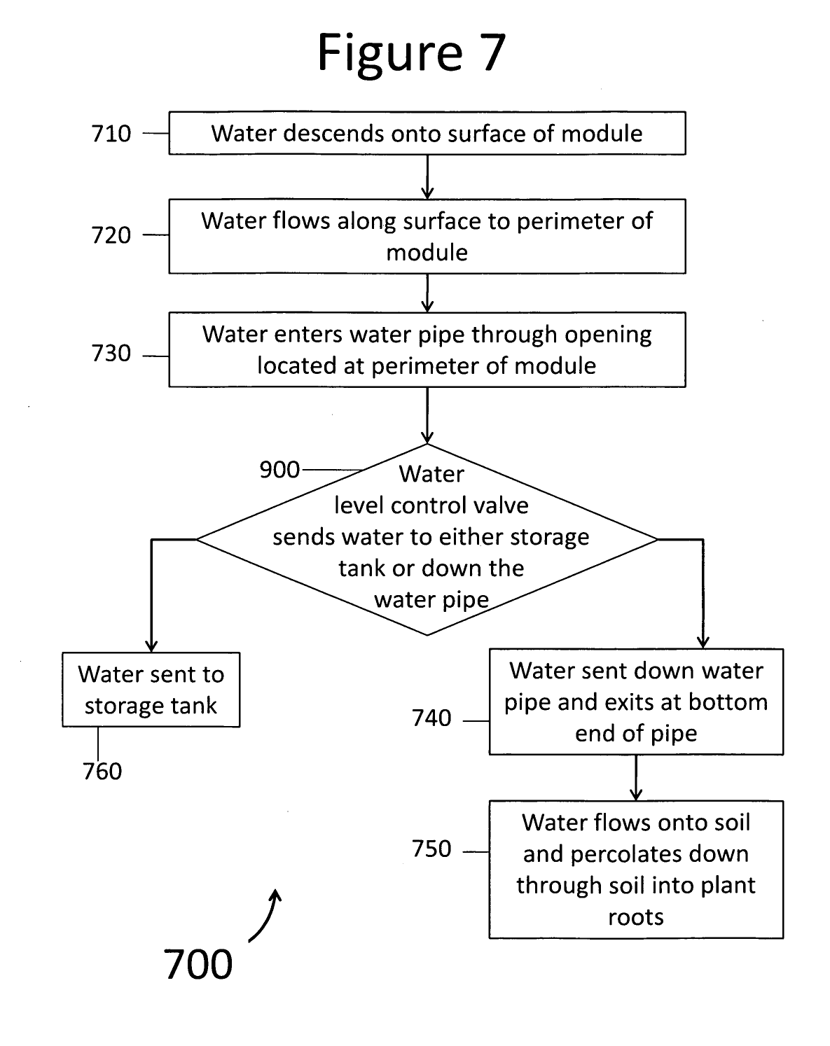

FIG. 7 illustrates a method for irrigating water 700 within a modular apparatus for an irrigation system 600 according to an embodiment of the present invention. First, in step 710, water descends onto the top surface of the module 630. The water may be intentionally sprayed onto the surface 630 by a watering can. Alternatively, the water may arrive naturally in the form of rainfall. The water then flows along the top surface 630 towards the perimeter of the surface 720. The top surface 630 may be slanted and therefore the water would flow towards the perimeter under the force of gravity. The water flow may alternatively result from the drag caused by water flowing down through the water pipe 640. As the water reaches the perimeter of the module, it enters the water pipe 640 through the pipe opening located at the module perimeter 730.

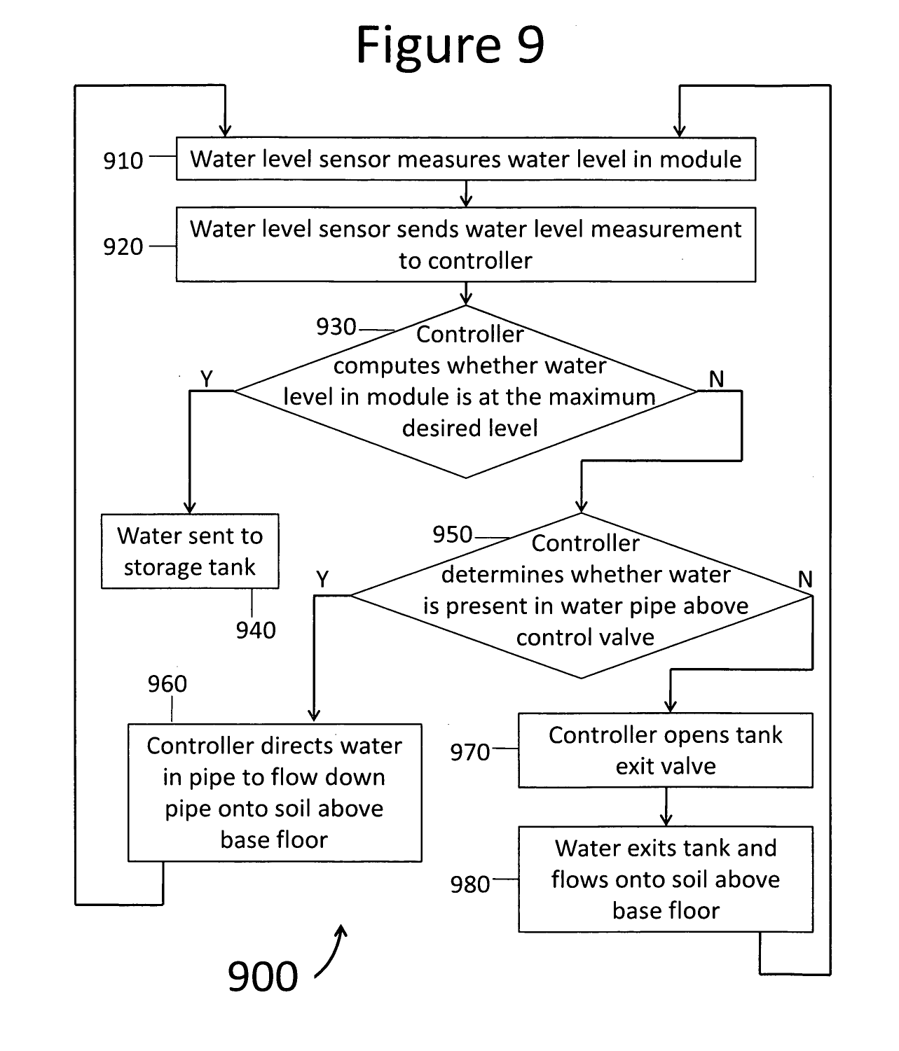

The water level control valve 820 then sends the water in one of two directions. The water is sent either to the storage tank, 760, or to the remainder of the water pipe 640, 740. The determination of where the water is sent is made by the water level controller 810. The method 900 by which this determination is made is shown in FIG. 9 and described in detail below. If the water is sent to the remainder of the water pipe 640, the water flows onto the nutrient layer 650 and then travels down through the soil into the plant roots 655. Through this method 700, water is transported from the surface of the module to the roots of the plant and the level of water within the module is kept under a predetermined maximum level.

FIG. 8 illustrates a block diagram of a water level control system 800. The water level control system 800 includes a valve controller 810, a control valve 820, a water level sensor 830, and a tank exit valve 840.

The valve controller 810 is in electronic communication with the control valve 820. The valve controller 810 is also in electronic communication with the tank exit valve 840. The valve controller 810 and the water level sensor 830 are in bi-directional electronic communication.

In operation, the water level sensor 830 continuously measures the level of water within a module. The sensor 830 then sends data representing the water level to the valve controller 810. The valve controller 810 processes the data that it receives and creates instructions to send to the control valve 820 and the tank exit valve 840. The instructions are created through the process described in FIG. 9 below. The valve controller 810 then sends the respective instructions that it has created to the control valve 820 and the tank exit valve 840. The instructions command the valves to either open or close. By opening and closing valves, the valve controller 810 may direct the flow of water within the module.

FIG. 9 illustrates a method 900 for controlling the water level within a modular apparatus for an irrigation system 600. First, in step 910, the water level sensor 830 measures the water level within the modular apparatus for an irrigation system 600. The water level sensor 830 then sends data representing the water level measurement to the valve controller 810. The controller 810 possesses data within its memory representing the maximum water level desired within the module 600. The controller 810 then computes whether the actual water level within the module is equal to or above the maximum desired level within the module 930. If the actual water level is greater than or equal to the maximum desired level, the controller 810 sends a signal to the control valve 820 to block passage down the water pipe 640. The water is thus directed, in step 940, through the tank inlet pipe 670 and subsequently flows into the storage tank 680. If the actual water level is less than the maximum desired level, the controller 810, in step 950, then determines whether water is present in the water pipe 640 above the control valve 820. If there is water above the control valve 820, the controller 810, in step 960, sends instructions to the control valve 820 to allow water to pass down through the water pipe 640. If there is no water present in the water pipe 640 above the control valve 810, the controller sends instructions to the tank exit valve 840 to open 970. In step 980, water from the storage tank 680 exits the tank and flows onto the nutrient layer 650. The water level sensor 830 then takes a new measurement of the water level within the module 600 and the method 900 for controlling the water level within the modular apparatus for an irrigation system 600 is repeated.

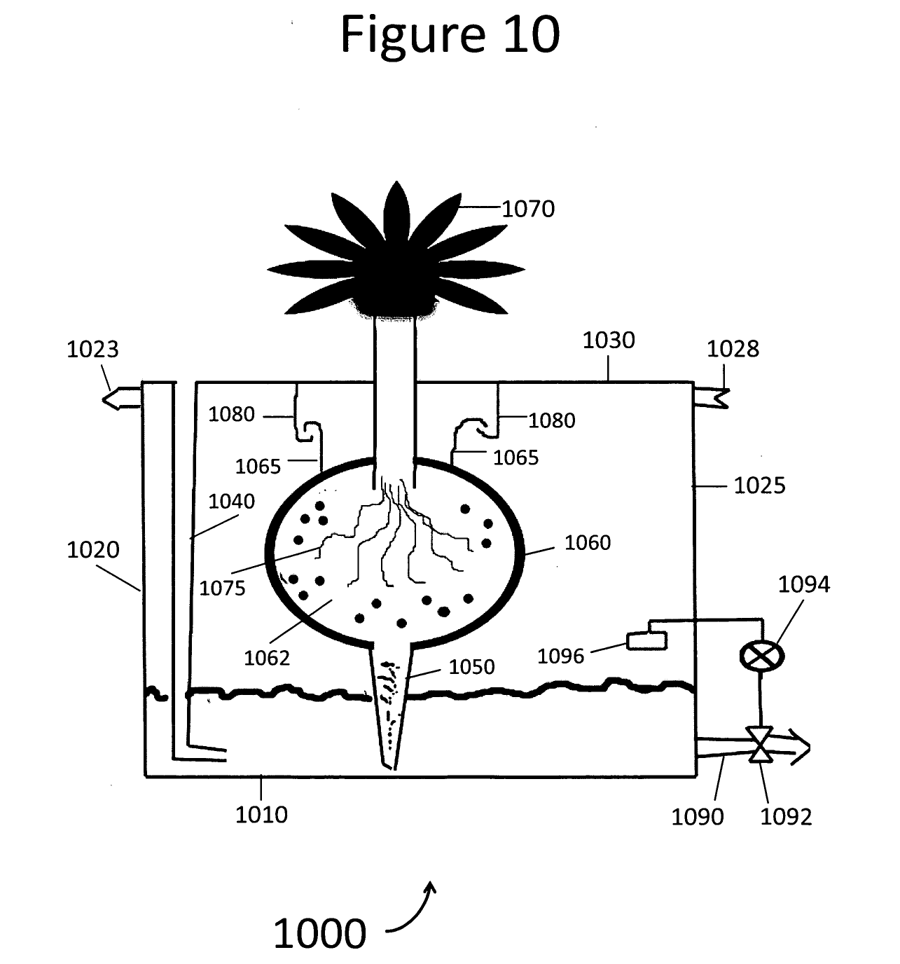

FIG. 10 illustrates a modular apparatus for an irrigation system 1000 according to an embodiment of the present invention. The modular apparatus for an irrigation system 1000 includes a base floor 1010, a left side wall 1020, a right side wall 1025, a connecting clasp 1023, a receiving clasp 1028, a top surface 1030, a water pipe 1040, a wick 1050, a nutrient bag 1060, a plant 1070, surface hooks 1080, an exit pipe 1090, an exit valve 1092, a exit controller 1094, and a water level measurement device 1096. The nutrient bag 1060 further includes bag hooks 1065.

The base floor 1010 is adjoined to left side wall 1020 along its left edge and is adjoined to right side wall 1025 along its right edge. A connecting clasp 1023 is affixed to the left side wall 1020. A receiving clasp 1028 is affixed to the right side wall 1025. The top surface 1030 intersects with the left side wall 1020 and the right side wall 1025. The base floor 1010, left side wall 1020, right side wall 1025, and top surface 1030 form a water retention chamber, within which water may be stored. The receiving end of the water pipe 1040 is located on the top surface 1030. The water pipe 1040 may be connected to the inside of a side wall 1020. The water pipe 1040 extends down towards the base floor 1010. The delivering end of the water pipe 1040 is located slightly above the base floor 1010. The tip of the wick 1050 rests on the base floor 1010. The wick 1050 extends vertically from the base floor 1010 into the nutrient bag 1060. The nutrient bag encases nutrient 1062. Bag hooks 1065 are attached to the surface of the nutrient bag 1060. Surface hooks 1080 are attached to the underside of the top surface 1030. The bag hooks 1065 and the surface hooks 1080 are oriented in opposite directions. The bag hooks 1065 are oriented in an inverted-J fashion. The surface hooks 1080 are oriented in a normal-J fashion. The orientations of the bag hooks 1065 and the surface hooks 1080 allow the hooks to link together. The ends of the bag hooks 1065 rest on the ends of the surface hooks 1080. The roots 1075 of the plant 1070 are embedded in the nutrient 1062. The trunk of the plant 1070 extends vertically from within the nutrient 1062 through an aperture in the top surface 1030. The vegetation of the plant 1070 is situated above the top surface 1030. The exit pipe 1090 is connected to the right side wall 1025, preferably towards the base of the right side wall 1025. The exit valve 1092 is installed on the exit pipe 1090. The exit controller 1094 is in electrical communication with the exit valve 1092. The exit controller 1094 is also in electrical communication with the water level sensor 1094.

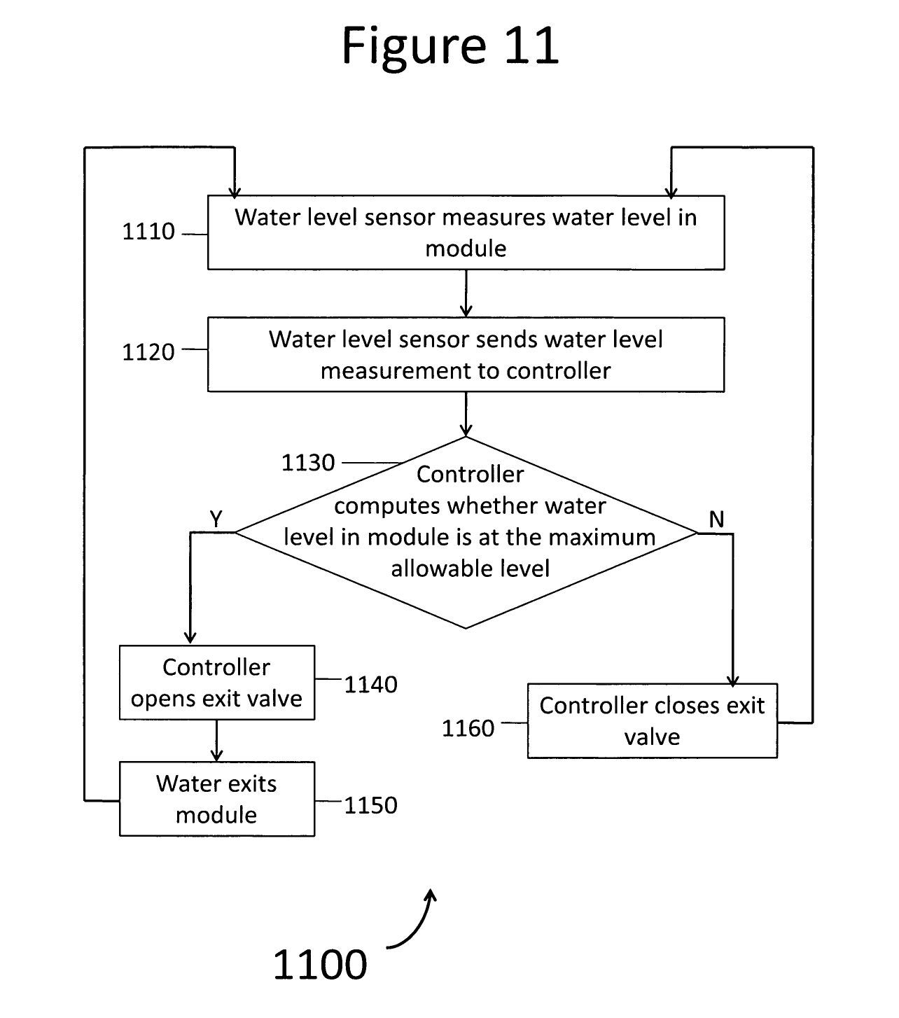

The vegetation of the plant 1070 receives light from an external light source such as the sun. The vegetation of the plant 1070 is also visible to observers of the modular apparatus for an irrigation system 1000. Water from an external source such as the atmosphere descends onto the top surface 1030 and the vegetation of the plant 1070. The top surface 1030 is impermeable. The water rests on the top surface 1030 and flows down the water pipe 1040. The water exits the water pipe 1040 and collects on the base floor 1010. The wick 1050 absorbs water that has collected on the base floor 1010. The wick 1050 continues to absorb water from the base floor 1010 until the wick 1050 is saturated. The water within the wick 1050 travels upwards along the wick 1050 until it reaches the interface between the top end of the wick 1050 and the nutrient 1062. The nutrient 1062 absorbs water from the wick 1050. The water percolates through the nutrient 1062 and reaches the interface between the roots 1075 and the nutrient 1062. The roots 1075 then absorb water from the nutrient 1062. The controller 1094 controls the level of water within the module 1000 by controlling the flow of water exiting the module through the exit pipe 1090. The method by which the controller regulates the water level within the module 1000 is explained further in FIG. 11. The modular apparatus for an irrigation system 1000 thus minimizes the weight of the module by draining excess water out of the system.

In an embodiment of the present invention, there is a plurality of apertures on the top surface 1030. Plants 1070 may be placed through each of these apertures. In an alternative embodiment of the present invention, the water may travel down towards the base floor 1010 via a channel rather than the water pipe 1040. In this embodiment, there remains an aperture on the top surface where the receiving end of the water pipe 1040 is ordinarily situated. The water pipe 1040 is replaced by a chute that guides the water down towards the base floor 1010. Alternatively, there may be neither a water pipe 1040 nor a chute. The water enters an aperture located on the top surface 1030 where the receiving end of the water pipe 1040 is ordinarily situated. The water then drops directly onto the base floor 1010.

The connecting clasp 1023 may connect with the receiving clasp 1028 of a second modular apparatus for an irrigation system 1000. Several modular apparatuses for an irrigation system 1000 may be connected together in this way.

In one embodiment of the modular apparatus for an irrigation system 1000, the left side wall 1020 and right side wall 1025 are made of plastic. Alternatively, the left side wall 1020 and right side wall 1025 may be made of a biodegradable material. The nutrient 1062 is preferably soil. The nutrient 1062 may also contain fertilizer. The water pipe 1040 may be made of various materials such as plastic or metal. The plant 1070 may be a small tree, bush, or vegetable. The top surface 1030 may be constructed so that it is parallel to the surface on which the modular apparatus for an irrigation system 1000 rests. Alternatively, the top surface 1030 may be slanted relative to the resting surface so that water on the top surface 1030 travels more quickly to the opening of the water pipe 1040.

In an alternative embodiment of the present invention, there is a plurality of wicks 1050. There may also be a plurality of water pipes 1040. The base floor 1010, left side wall 1020, right side wall 1025, and top surface 1030 may be adjoined so as to form a cube. Alternatively, the base floor 1010, left side wall 1020, right side wall 1025, and top surface 1030 may form a three-dimensional rectangle, trapezoid or other shape. The base floor 1010, left side wall 1020, right side wall 1025, and top surface 1030 may also be curved so that the modular apparatus 1000 is spherical.

The use of the connecting clasp 1023 and the receiving clasp 1028 to interconnect modular apparatuses for an irrigation system 1000 may be replaced by various alternative connecting mechanisms. For example, the left side wall 1020 and right side wall 1025 may feature grooves along their surfaces that allow modules to fit together. Alternatively, the left side wall 1020 and right side wall 1025 may contain lips along their edges that would enable the modules to hook together. The exit pipe 1090 may alternatively be connected to the left side wall 1020 rather than the right side wall 1025. In another embodiment, the exit pipe 1090 may be connected to the base floor 1010.

FIG. 11 illustrates a flow diagram of a method 1100 for controlling the water level within the modular apparatus for an irrigation system 1000 according to an embodiment of the present invention. First, in step 1110, the water level sensor 1096 measures the water level within the module 1000. In step 1120, the sensor 1096 sends data representing the water level measurement to the controller 1094. The controller has stored in its memory data representing the maximum allowable water level within the module 1000. The controller 1094 compares the actual water level to the maximum allowable water level 1130. If the actual water level exceeds the maximum allowable level, the controller 1092 sends instructions to the exit valve 1094 to open 1140. Water then exits the module through the exit pipe 1090. If the actual water level does not exceed the maximum water level, the controller 1092 sends instructions to the exit valve 1094 to close 1160. In this instance, no water leaves the system. The sensor 1096 then measures the water level again and the method for controlling the water level within the modular apparatus 1000 is repeated.

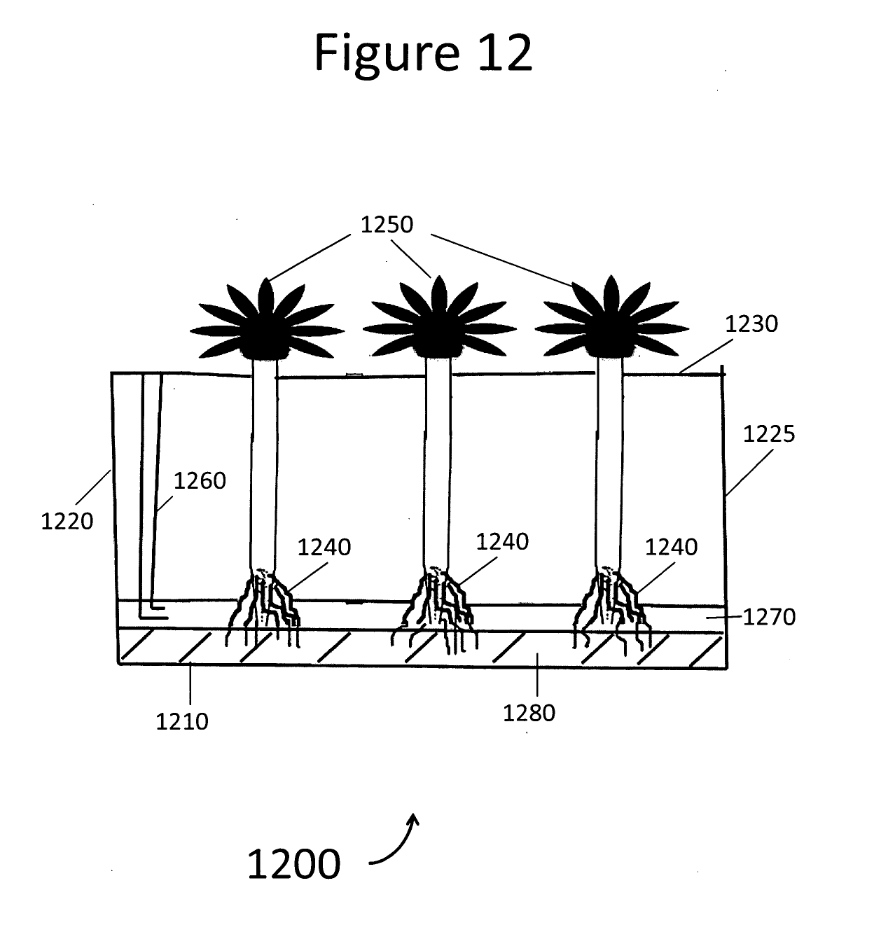

FIG. 12 illustrates a tray apparatus for an irrigation system 1200 according to an embodiment of the present invention. The tray apparatus 1200 includes a base floor 1210, a left side wall 1220, a right side wall 1225, a top surface 1230, a plurality of vertical protrusions 1240, a plurality of plants 1250, a water pipe 1260, an upper base floor 1270, and a nutrient layer 1280.

The base floor 1210 is adjoined to left side wall 1220 along its left edge and is adjoined to right side wall 1225 along its right edge. The upper base floor 1270 intersects with the left side wall 1220 and the right side wall 1225. The upper base floor 1270 is located between the base floor 1210 and the top surface 1230. The top surface 1230 intersects with the left side wall 1220 and the right side wall 1225. The receiving end of the water pipe 1260 is located on the top surface 1230. The water pipe 1260 may be connected to the inside of left side wall 1220 or right side wall 1225. The water pipe 1260 extends down towards the base floor 1210. The delivering end of the water pipe 1260 is located slightly above the base floor 1210 and below the upper base floor 1270. The vertical protrusions 1240 are connected to the upper base floor 1270. The vertical protrusions 1240 and the upper base floor 1270 are part of a single mold. The nutrient layer 1280 rests on the base floor 1210. The roots of a plant 1250 are housed within a vertical protrusion 1240. The roots of a plant 1250 extend down into the nutrient layer 1280.

The vegetation of the plants 1250 receives light from an external light source such as the sun. The vegetation of the plants 1250 is also visible to observers of the tray apparatus for an irrigation system 1200. The plants 1250 are held fixed in place by the vertical protrusions 1240. The trunks of the plants 1250 extend vertically from within the vertical protrusions 1240 through apertures on the top surface 1230. Water from an external source such as the atmosphere descends onto the top surface 1230 and the vegetation of the plants 1260. The top surface 1230 is impermeable. The water rests on the top surface 1230 and flows down the water pipe 1260. The water exits the water pipe 1260 and flows onto the nutrient layer 1280. The water flows down through the nutrient layer 1280. As the water percolates through the nutrient layer 1280, it extracts nutrient from the soil. The plant roots absorb water from the nutrient layer 1280.

If the nutrient layer 1280 is saturated with water, water flowing out from the water pipe 1260 collects at the surface of nutrient layer 1280. The water does not flow down through the soil until the soil is no longer saturated. Water resting on the nutrient layer 1280 gradually evaporates. Some of the water vapor is absorbed by the trunk of the plant 1250.

The nutrient layer 1280 is preferably soil. The nutrient layer 1280 may also contain fertilizer. The water pipe 1260 may be made of various materials such as plastic or metal. The plant 1250 may be a small tree, bush, or vegetable. The top surface 1230 may be constructed so that it is parallel to the surface on which the tray apparatus for an irrigation system 1200 rests. Alternatively, the top surface 1230 may be slanted relative to the resting surface so that water on the top surface 1230 travels more quickly to the opening of the water pipe 1260.

In a preferred embodiment of the present invention, the enclosure formed by the left side wall 1220, right side wall 1225, upper base floor 1270, and top surface 1230 is hollow space. Alternatively, the enclosure may be packed with filler material such as gravel or sand to make the module heavier.

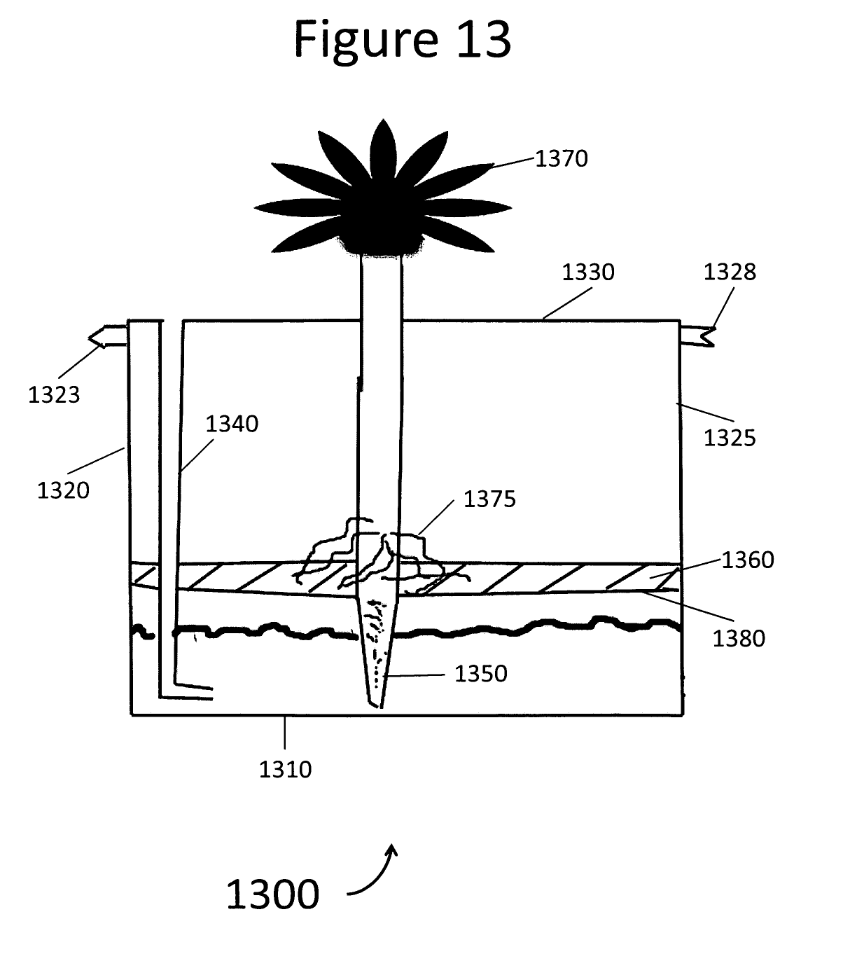

FIG. 13 illustrates a modular apparatus for an irrigation system 1300 according to an embodiment of the present invention. The modular apparatus for an irrigation system 1300 includes a base floor 1310, a left side wall 1320, a right side wall 1325, a connecting clasp 1323, a receiving clasp 1328, a top surface 1330, a water pipe 1340, a wick 1350, a nutrient layer 1360, a plant 1370, and a nutrient tray 1380.

The base floor 1310 is adjoined to left side wall 1320 along its left edge and is adjoined to right side wall 1325 along its right edge. A connecting clasp 1323 is affixed to the left side wall 1320. A receiving clasp 1328 is affixed to the right side wall 1325. The top surface 1330 intersects with the left side wall 1320 and the right side wall 1325. The base floor 1310, left side wall 1320, right side wall 1325, and top surface 1330 form a water retention chamber, within which water may be stored. The receiving end of the water pipe 1340 is located on the top surface 1330. The water pipe 1340 may be connected to the inside of a side wall 1320. The water pipe 1340 extends down towards the base floor 1310. The delivering end of the water pipe 1340 is located slightly above the base floor 1310. The tip of the wick 1350 rests on the base floor 1310. The wick 1350 extends vertically from the base floor 1310 into the nutrient layer 1360 through an opening in the nutrient tray 1380. The nutrient layer 1360 rests on the nutrient tray 1380. The roots 1375 of the plant 1370 are embedded in the nutrient layer 1360. The trunk of the plant 1370 extends vertically from within the nutrient layer 1360 through an aperture in the top surface 1330. The vegetation of the plant 1370 is situated above the top surface 1330.

The vegetation of the plant 1370 receives light from an external light source such as the sun. The vegetation of the plant 1370 is also visible to observers of the modular apparatus for an irrigation system 1300. Water from an external source such as the atmosphere descends onto the top surface 1330 and the vegetation of the plant 1370. The top surface 1330 is impermeable. The water rests on the top surface 1330 and flows down the water pipe 1340. The water exits the water pipe 1340 and collects on the base floor 1310. The wick 1350 absorbs water that has collected on the base floor 1310. The wick 1350 continues to absorb water from the base floor 1310 until the wick 1350 is saturated. The water within the wick 1350 travels upwards along the wick 1350 until it reaches the interface between the top end of the wick 1350 and the nutrient 1360. The nutrient 1360 absorbs water from the wick 1350. The water percolates through the nutrient 1362 and reaches the interface between the roots 1375 and the nutrient 1360. The roots 1375 then absorb water from the nutrient 1360. The modular apparatus for an irrigation system 1300 thus houses a plant that is nourished with light, nutrient, and water. Water and nutrient are provided to the plant through sub-irrigation and wicking technology.

In an embodiment of the present invention, there is a plurality of apertures on the top surface 1330. Plants 1370 may be placed through each of these apertures. In an alternative embodiment of the present invention, the water may travel down towards the base floor 1310 via a channel rather than the water pipe 1340. In this embodiment, there remains an aperture on the top surface where the receiving end of the water pipe 1340 is ordinarily situated. The water pipe 1340 is replaced by a chute that guides the water down towards the base floor 1310. Alternatively, there may be neither a water pipe 1340 nor a chute. The water enters an aperture located on the top surface 1330 where the receiving end of the water pipe 1340 is ordinarily situated. The water then drops directly onto the base floor 1310.

The connecting clasp 1323 may connect with the receiving clasp 1328 of a second modular apparatus for an irrigation system 1300. Several modular apparatuses for an irrigation system 1300 may be connected together in this way.

In one embodiment of the modular apparatus for an irrigation system 1300, the left side wall 1320 and right side wall 1325 are made of plastic. Alternatively, the left side wall 1320 and right side wall 1325 may be made of a biodegradable material. The nutrient 1360 is preferably soil. The nutrient 1360 may also contain fertilizer. The water pipe 1340 may be made of various materials such as plastic or metal. The plant 1370 may be a small tree, bush, or vegetable. The top surface 1330 may be constructed so that it is parallel to the surface on which the modular apparatus for an irrigation system 1300 rests. Alternatively, the top surface 1330 may be slanted relative to the resting surface so that water on the top surface 1330 travels more quickly to the opening of the water pipe 1340.

In an alternative embodiment of the present invention, there is a plurality of wicks 1350. There may also be a plurality of water pipes 1340 through which water may travel to the water retention chamber. The base floor 1310, left side wall 1320, right side wall 1325, and top surface 1330 may be adjoined so as to form a cube. Alternatively, the base floor 1310, left side wall 1320, right side wall 1325, and top surface 1330 may form a three-dimensional rectangle, trapezoid or other shape. The base floor 1310, left side wall 1320, right side wall 1325, and top surface 1330 may also be curved so that the modular apparatus 1300 is spherical.

The use of the connecting clasp 1323 and the receiving clasp 1328 to interconnect modular apparatuses for an irrigation system 1300 may be replaced by various alternative connecting mechanisms. For example, the left side wall 1320 and right side wall 1325 may feature grooves along their surfaces that allow modules to fit together. Alternatively, the left side wall 1320 and right side wall 1325 may contain lips along their edges that would enable the modules to hook together.

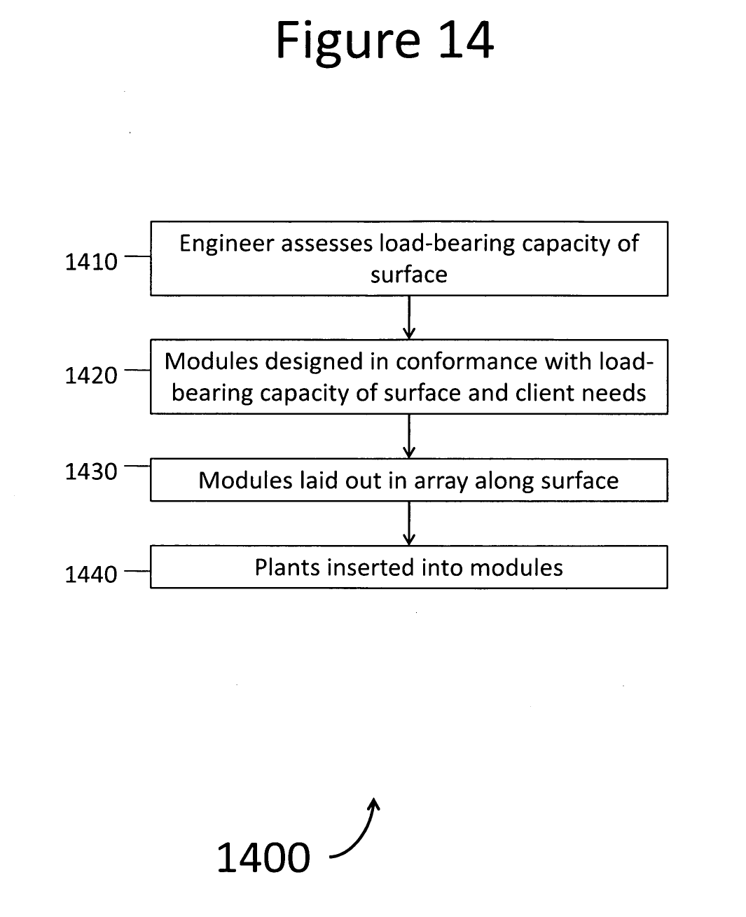

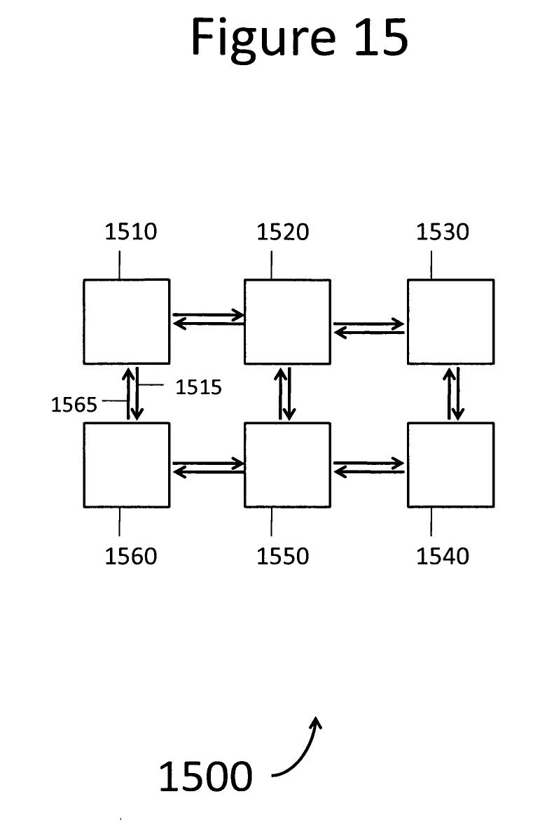

FIG. 14 illustrates a flow chart for a method for installing modular apparatuses for an irrigation system on a surface 1400. First, a competent professional such as a structural engineer assesses the load-bearing capacity of the surface 1410. The modular apparatuses are then designed to be in conformance with both the load-bearing capacity of the surface as well client needs 1420. The modular apparatuses may be any of the embodiments of the present invention that have been discussed above in FIGS. 1, 4, 6, 10, and 13. The size of the modules is influenced by the load-bearing capacity of the surface. The modules may be larger where the surface is able to support large loads. Furthermore, a particular embodiment may be more appropriate for a given surface. For example, a surface may receive water only through rare, large deliveries. For such a surface, a module that comprises a storage tank, such as the module described by FIG. 6, is more suitable. The modules are then laid out in an array along the surface 1430. The modules may be connected by fastening means available on the modules as illustrated in FIG. 15. Finally, plants are inserted into the modules 1440. An array of modules with vegetation that may be easily maintained is now installed on the surface.

In a preferred embodiment of the present invention, the surface on which the modules are installed is a roof. Alternatively, the surface may be a balcony, porch, or other outdoors surface. The plants inserted into the modules may be standard plants, hydroponic plants, or vegetables.

FIG. 15 illustrates a block diagram of an array of modular apparatuses for an irrigation system 1500. The array of modules 1500 includes modules 1510, 1520, 1530, 1540, 1550 and 1560. The array further includes connecting clasps 1515 and receiving clasps 1565. These clasps are included on each module.

The modules are placed adjacent to one another on a given surface as illustrated in FIG. 15. The connecting clasp 1515 of one module connects to the receiving clasp 1565 of an adjacent module. The adjacent modules are thereby interconnected.

FIG. 15 illustrates a small sample array that may be constructed using the modular apparatuses of the present invention. The array may be larger or smaller depending on the size and integrity of the surface on which the modules rest. The modules within the array may be of different sizes. The array of modules may comprise a combination of different embodiments of the modular apparatus for an irrigation system that are described by the present invention. For example, the array may comprise modular apparatuses for an irrigation system 100, 600, and 1000. As a result, the array may include modules that do not have a storage tank and accompanying control system, other modules that do have a storage tank and control system, and modules that have an exit pipe and control system and others that do not.

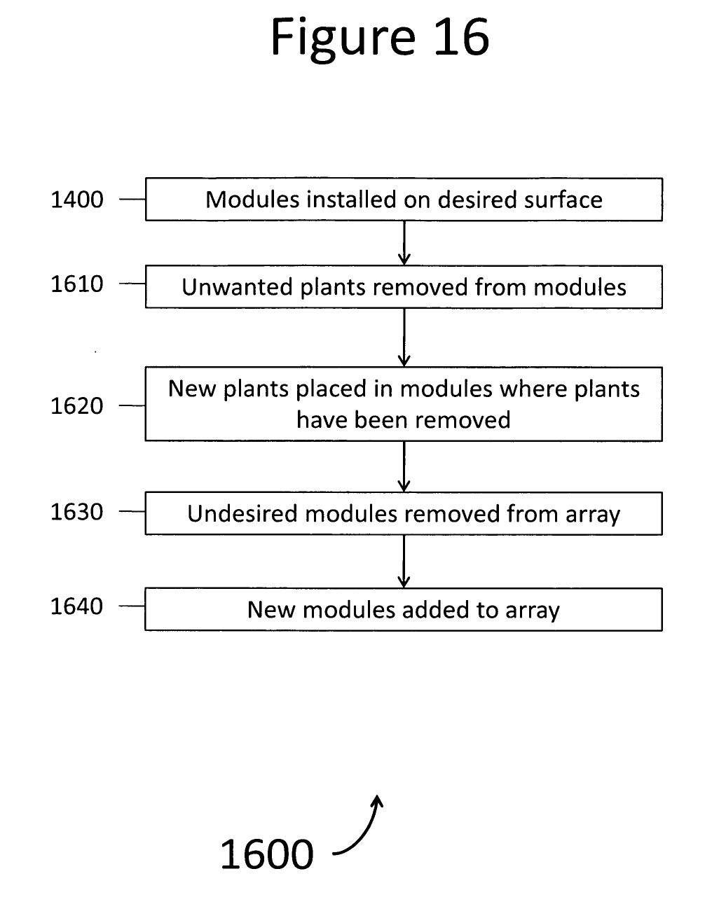

FIG. 16 illustrates a method for maintaining a modular irrigation system with vegetation. Modular apparatuses for an irrigation system are first installed on the desired surface as described by FIG. 14. At a later time, unwanted plants may be removed from any of the modules 1610. New plants may then be placed in those modules where plants have been removed 1620. In addition to removing particular plants, entire modules may be detached from its neighboring modules and removed from the array 1630. New modules may also be added to the existing array 1640.

In a preferred embodiment of the present invention, the surface on which the modules are installed is a roof. Alternatively, the surface may be a balcony, porch, or other outdoors surface. The plants inserted into the modules may be standard plants, hydroponic plants, or vegetables. Hydroponic plants may be grown year-round and may be added to modules at any time of the year regardless of the season. Plants may be removed from a module without disturbing the health of other plants. The removal of a plant from a module does not harm the health of that module and a newly added plant continues to grow healthily within the module.

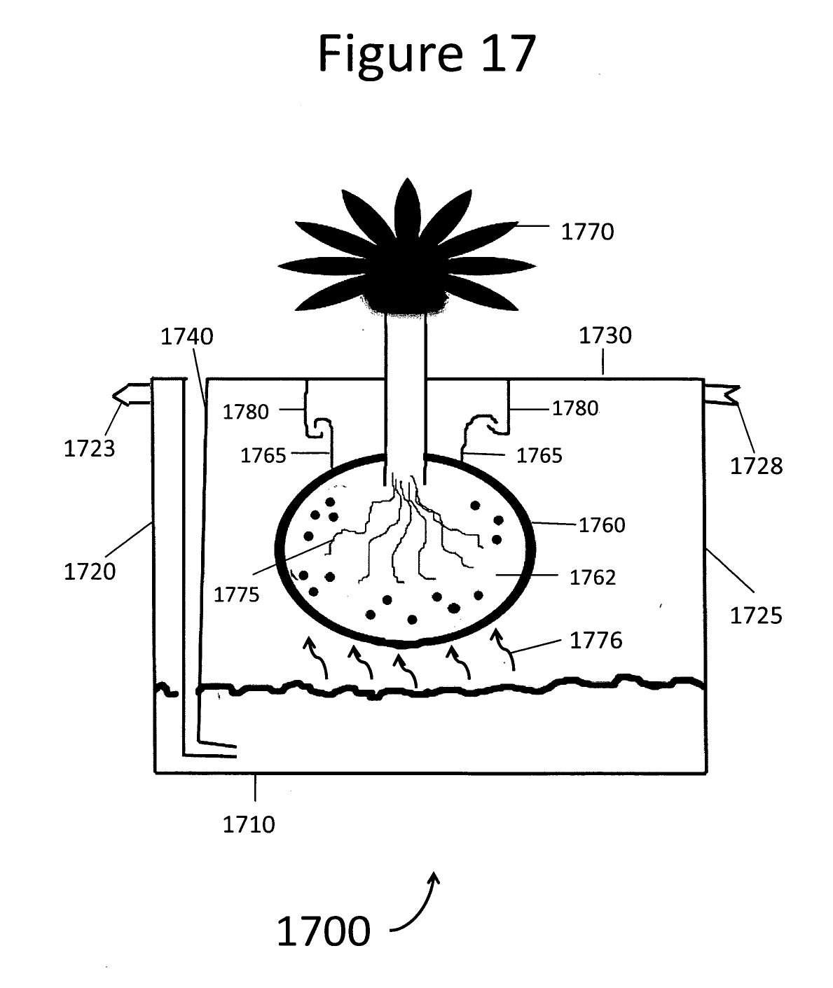

FIG. 17 illustrates a modular apparatus for an irrigation system 1700 according to an embodiment of the present invention. The modular apparatus for an irrigation system 1700 includes a base floor 1710, a left side wall 1720, a right side wall 1725, a connecting clasp 1723, a receiving clasp 1728, a top surface 1730, a water pipe 1740, a nutrient bag 1760, a plant 1770, and surface hooks 1780. The nutrient bag 1760 further includes bag hooks 1765.

The base floor 1710 is adjoined to left side wall 1720 along its left edge and is adjoined to right side wall 1725 along its right edge. A connecting clasp 1723 is affixed to the left side wall 1720. A receiving clasp 1728 is affixed to the right side wall 1725. The top surface 1730 intersects with the left side wall 1720 and the right side wall 1725. The base floor 1710, left side wall 1720, right side wall 1725, and top surface 1730 form a water retention chamber, within which water may be stored. The receiving end of the water pipe 1740 is located on the top surface 1730. The water pipe 1740 may be connected to the inside of a side wall 1720. The water pipe 1740 extends down towards the base floor 1710. The delivering end of the water pipe 1740 is located slightly above the base floor 1710. The nutrient bag 1760 encases nutrient 1762. Bag hooks 1765 are attached to the surface of the nutrient bag 1760. Surface hooks 1780 are attached to the underside of the top surface 1730. The bag hooks 1765 and the surface hooks 1780 are oriented in opposite directions. The bag hooks 1765 are oriented in an inverted-J fashion. The surface hooks 1780 are oriented in a normal-J fashion. The orientations of the bag hooks 1765 and the surface hooks 1780 allow the hooks to link together. The ends of the bag hooks 1765 rest on the ends of the surface hooks 1780. The roots 1775 of the plant 1770 are embedded in the nutrient 1762. The trunk of the plant 1770 extends vertically from within the nutrient 1762 through an aperture in the top surface 1730. The vegetation of the plant 1770 is situated above the top surface 1730.

The vegetation of the plant 1770 receives light from an external light source such as the sun. The vegetation of the plant 1770 is also visible to observers of the modular apparatus for an irrigation system 1700. Water from an external source such as the atmosphere descends onto the top surface 1730 and the vegetation of the plant 1770. The top surface 1730 is impermeable. The water rests on the top surface 1730 and flows down the water pipe 1740. The water exits the water pipe 1740 and collects on the base floor 1710. The water gradually evaporates off the base floor 1710 in the form of water vapor 1776. The water vapor 1776 rises and comes into contact with the nutrient bag 1760. The water vapor 1776 passes through the nutrient bag 1760 and is absorbed by the nutrient 1762. The water percolates through the nutrient 1762 and reaches the interface between the roots 1775 and the nutrient 1762. The roots 1775 then absorb water from the nutrient 1762. The modular apparatus for an irrigation system 1700 thus houses a plant that is nourished with light, nutrient, and water. The water is provided to the plant through sub-irrigation without the need for wicking technology.

In an embodiment of the present invention, there is a plurality of apertures on the top surface 1730. Plants 1770 may be placed through each of these apertures. In an alternative embodiment of the present invention, the water may travel down towards the base floor 1710 via a channel rather than the water pipe 1740. In this embodiment, there remains an aperture on the top surface where the receiving end of the water pipe 1740 is ordinarily situated. The water pipe 1740 is replaced by a chute that guides the water down towards the base floor 1710. Alternatively, there may be neither a water pipe 1740 nor a chute. The water enters an aperture located on the top surface 1730 where the receiving end of the water pipe 1740 is ordinarily situated. The water then drops directly onto the base floor 1710.

The connecting clasp 1723 may connect with the receiving clasp 1728 of a second modular apparatus for an irrigation system 1700. Several modular apparatuses for an irrigation system 1700 may be connected together in this way.

In one embodiment of the modular apparatus for an irrigation system 1700, the left side wall 1720 and right side wall 1725 are made of plastic. Alternatively, the left side wall 1720 and right side wall 1725 may be made of a biodegradable material. The nutrient 1762 is preferably soil. The nutrient 1762 may also contain fertilizer. The water pipe 1740 may be made of various materials such as plastic or metal. The plant 1770 may be a small tree, bush, or vegetable. The top surface 1730 may be constructed so that it is parallel to the surface on which the modular apparatus for an irrigation system 1700 rests. Alternatively, the top surface 1730 may be slanted relative to the resting surface so that water on the top surface 1730 travels more quickly to the opening of the water pipe 1740.

In an alternative embodiment of the present invention, there is a plurality of water pipes 1740 through which water may travel to the water retention chamber. The base floor 1710, left side wall 1720, right side wall 1725, and top surface 1730 may be adjoined so as to form a cube. Alternatively, the base floor 1710, left side wall 1720, right side wall 1725, and top surface 1730 may form a three-dimensional rectangle, trapezoid or other shape. The base floor 1710, left side wall 1720, right side wall 1725, and top surface 1730 may also be curved so that the modular apparatus 1700 is spherical.

The use of the connecting clasp 1723 and the receiving clasp 1728 to interconnect modular apparatuses for an irrigation system 1700 may be replaced by various alternative connecting mechanisms. For example, the left side wall 1720 and right side wall 1725 may feature grooves along their surfaces that allow modules to fit together. Alternatively, the left side wall 1720 and right side wall 1725 may contain lips along their edges that would enable the modules to hook together.

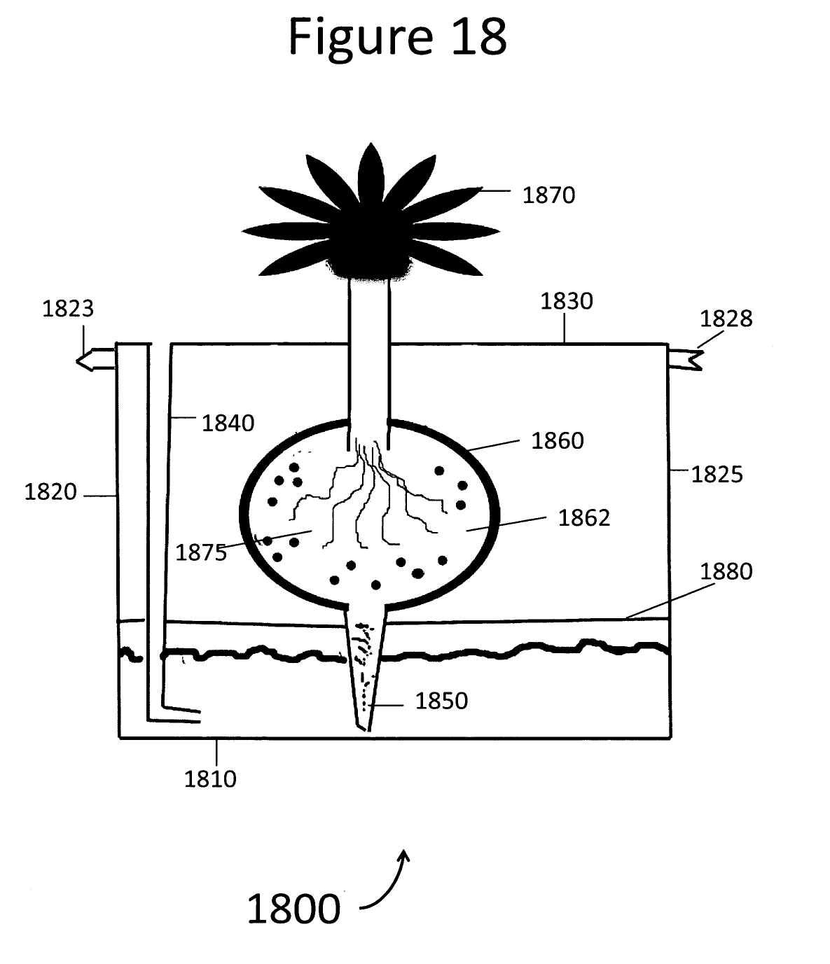

FIG. 18 illustrates a modular apparatus for an irrigation system 1800 according to an embodiment of the present invention. The modular apparatus for an irrigation system 1800 includes a base floor 1810, a left side wall 1820, a right side wall 1825, a connecting clasp 1823, a receiving clasp 1828, a top surface 1830, a water pipe 1840, a wick 1850, a nutrient bag 1860, nutrient 1862, a plant 1870, plant roots 1875, and a nutrient tray 1880.

The base floor 1810 is adjoined to left side wall 1820 along its left edge and is adjoined to right side wall 1825 along its right edge. A connecting clasp 1823 is affixed to the left side wall 1820. A receiving clasp 1828 is affixed to the right side wall 1825. The top surface 1830 intersects with the left side wall 1820 and the right side wall 1825. The base floor 1810, left side wall 1820, right side wall 1825, and top surface 1830 form a water retention chamber, within which water may be stored. The receiving end of the water pipe 1840 is located on the top surface 1830. The water pipe 1840 may be connected to the inside of a side wall 1820. The water pipe 1840 extends down towards the base floor 1810. The delivering end of the water pipe 1840 is located slightly above the base floor 1810. The tip of the wick 1850 rests on the base floor 1810. The wick 1850 extends vertically from the base floor 1810 into the nutrient bag 1860 through an opening in the nutrient tray 1880. The nutrient bag 1860 rests on the nutrient tray 1880. The roots 1875 of the plant 1870 are encased in the nutrient bag 1860. The trunk of the plant 1870 extends vertically from within the nutrient bag 1860 through an aperture in the top surface 1830. The vegetation of the plant 1870 is situated above the top surface 1830.

The vegetation of the plant 1870 receives light from an external light source such as the sun. The vegetation of the plant 1870 is also visible to observers of the modular apparatus for an irrigation system 1800. Water from an external source such as the atmosphere descends onto the top surface 1830 and the vegetation of the plant 1870. The top surface 1830 is impermeable. The water rests on the top surface 1830 and flows down the water pipe 1840. The water exits the water pipe 1840 and collects on the base floor 1810. The wick 1850 absorbs water that has collected on the base floor 1810. The wick 1850 continues to absorb water from the base floor 1810 until the wick 1850 is saturated. The water within the wick 1850 travels upwards along the wick 1850 until it reaches the interface between the top end of the wick 1850 and the nutrient 1862. The nutrient 1862 absorbs water from the wick 1850. The water percolates through the nutrient 1862 and reaches the interface between the roots 1875 and the nutrient 1862. The roots 1875 then absorb water from the nutrient 1862. The modular apparatus for an irrigation system 1800 thus houses a plant that is nourished with light, nutrient, and water. Water and nutrient are provided to the plant through sub-irrigation and wicking technology.

In an embodiment of the present invention, there is a plurality of apertures on the top surface 1830. Plants 1870 may be placed through each of these apertures. In an alternative embodiment of the present invention, the water may travel down towards the base floor 1810 via a channel rather than the water pipe 1840. In this embodiment, there remains an aperture on the top surface where the receiving end of the water pipe 1840 is ordinarily situated. The water pipe 1840 is replaced by a chute that guides the water down towards the base floor 1810. Alternatively, there may be neither a water pipe 1840 nor a chute. The water enters an aperture located on the top surface 1830 where the receiving end of the water pipe 1840 is ordinarily situated. The water then drops directly onto the base floor 1810.

The connecting clasp 1823 may connect with the receiving clasp 1828 of a second modular apparatus for an irrigation system 1800. Several modular apparatuses for an irrigation system 1800 may be connected together in this way.

In one embodiment of the modular apparatus for an irrigation system 1800, the left side wall 1820 and right side wall 1825 are made of plastic. Alternatively, the left side wall 1820 and right side wall 1825 may be made of a biodegradable material. The nutrient 1862 is preferably soil. The nutrient 1862 may also contain fertilizer. The water pipe 1840 may be made of various materials such as plastic or steel. The plant 1870 may be a small tree, bush, or vegetable. The top surface 1830 may be constructed so that it is parallel to the surface on which the modular apparatus for an irrigation system 1800 rests. Alternatively, the top surface 1830 may be slanted relative to the resting surface so that water on the top surface 1830 travels more quickly to the opening of the water pipe 1840.

In an alternative embodiment of the present invention, there is a plurality of wicks 1850. There may also be a plurality of water pipes 1840. The base floor 1810, left side wall 1820, right side wall 1825, and top surface 1830 may be adjoined so as to form a cube. Alternatively, the base floor 1810, left side wall 1820, right side wall 1825, and top surface 1830 may form a three-dimensional rectangle, trapezoid or other shape. The base floor 1810, left side wall 1820, right side wall 1825, and top surface 1830 may also be curved so that the modular apparatus 1800 is spherical.

The use of the connecting clasp 1823 and the receiving clasp 1828 to interconnect modular apparatuses for an irrigation system 1800 may be replaced by various alternative connecting mechanisms. For example, the left side wall 1820 and right side wall 1825 may feature grooves along their surfaces that allow modules to fit together. Alternatively, the left side wall 1820 and right side wall 1825 may contain lips along their edges that would enable the modules to hook together.

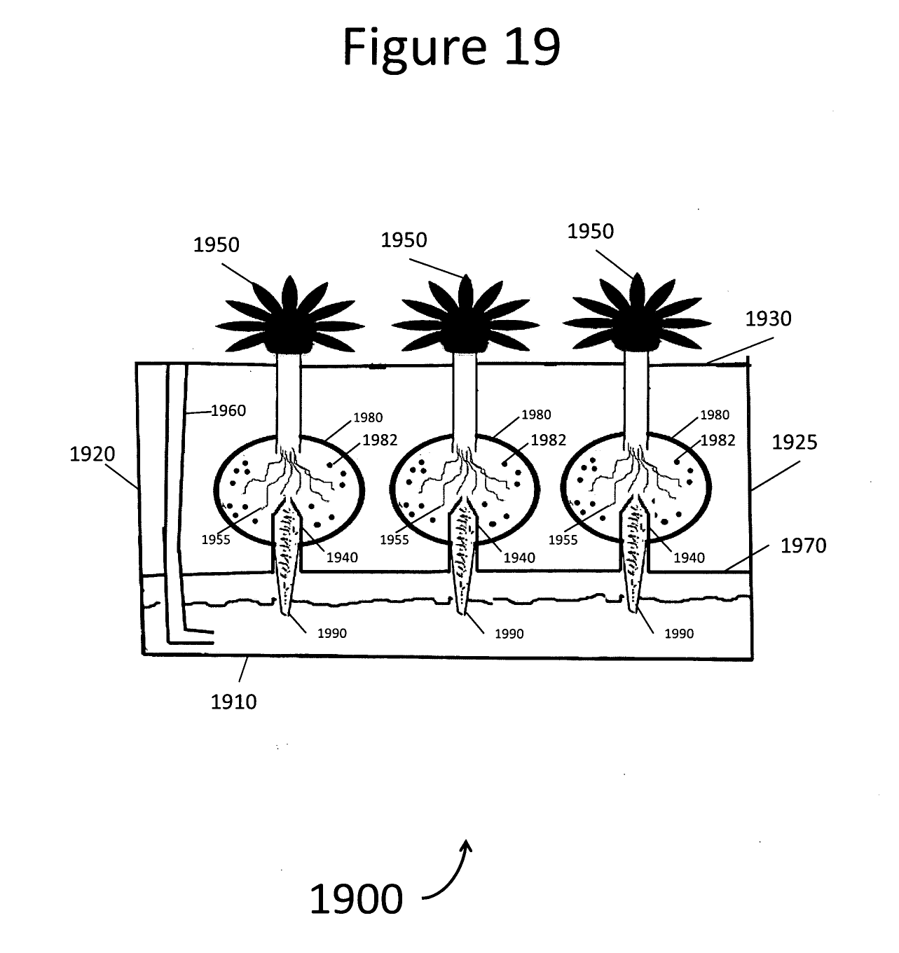

FIG. 19 illustrates a tray apparatus for an irrigation system 1900 according to an embodiment of the present invention. The tray apparatus 1900 includes a base floor 1910, a left side wall 1920, a right side wall 1925, a top surface 1930, a plurality of vertical protrusions 1940, a plurality of plants 1950, plant roots 1955, a water pipe 1960, an upper base floor 1970, a plurality of nutrient bags 1980, and a plurality of wicks 1990. The nutrient bags 1980 contain nutrient 1982.

The base floor 1910 is adjoined to left side wall 1920 along its left edge and is adjoined to right side wall 1925 along its right edge. The upper base floor 1970 intersects with the left side wall 1920 and the right side wall 1925. The upper base floor 1970 is located between the base floor 1910 and the top surface 1930. The top surface 1930 intersects with the left side wall 1920 and the right side wall 1925. The receiving end of the water pipe 1960 is located on the top surface 1930. The water pipe 1960 may be connected to the inside of left side wall 1920 or right side wall 1925. The water pipe 1960 extends down towards the base floor 1910. The delivering end of the water pipe 1960 is located slightly above the base floor 1910 and below the upper base floor 1970. The vertical protrusions 1940 are connected to the upper base floor 1970. The vertical protrusions 1940 and the upper base floor 1970 are part of a single mold. The wicks 1990 are attached to the base floor 1910. The wicks 1990 extend vertically from the base floor 1910 into the nutrient bags 1980. The nutrient bags 1980 sit within the interior of the vertical protrusions 1940. The nutrient bags 1980 are supported by the upper base floor 1970. The roots 1955 are housed within a nutrient bag 1980.

The vegetation of the plants 1950 receives light from an external light source such as the sun. The vegetation of the plants 1950 is also visible to observers of the tray apparatus for an irrigation system 1900. The plants 1950 are held fixed in place by the vertical protrusions 1940. The trunks of the plants 1950 extend vertically from within the vertical protrusions 1940 through apertures on the top surface 1930. Water from an external source such as the atmosphere descends onto the top surface 1930 and the vegetation of the plants 1960. The top surface 1930 is impermeable. The water rests on the top surface 1930 and flows down the water pipe 1960. The water exits the water pipe 1960 and flows onto the base floor 1910. The wicks 1990 absorb water. The water travels along the wicks 1990 and reaches the interface between the wicks 1990 and the nutrient 1982. The water is absorbed by the nutrient 1982, and travels through the nutrient. The water extracts nutrient from the nutrient 1982. The plant roots absorb water from the nutrient 1982.

The nutrient 1982 is preferably soil. The nutrient 1982 may also contain fertilizer. The water pipe 1960 may be made of various materials such as plastic or metal. The plants 1950 may be small trees bushes, or vegetables. The top surface 1930 may be constructed so that it is parallel to the surface on which the tray apparatus for an irrigation system 1900 rests. Alternatively, the top surface 1930 may be slanted relative to the resting surface so that water on the top surface 1930 travels more quickly to the opening of the water pipe 1960.

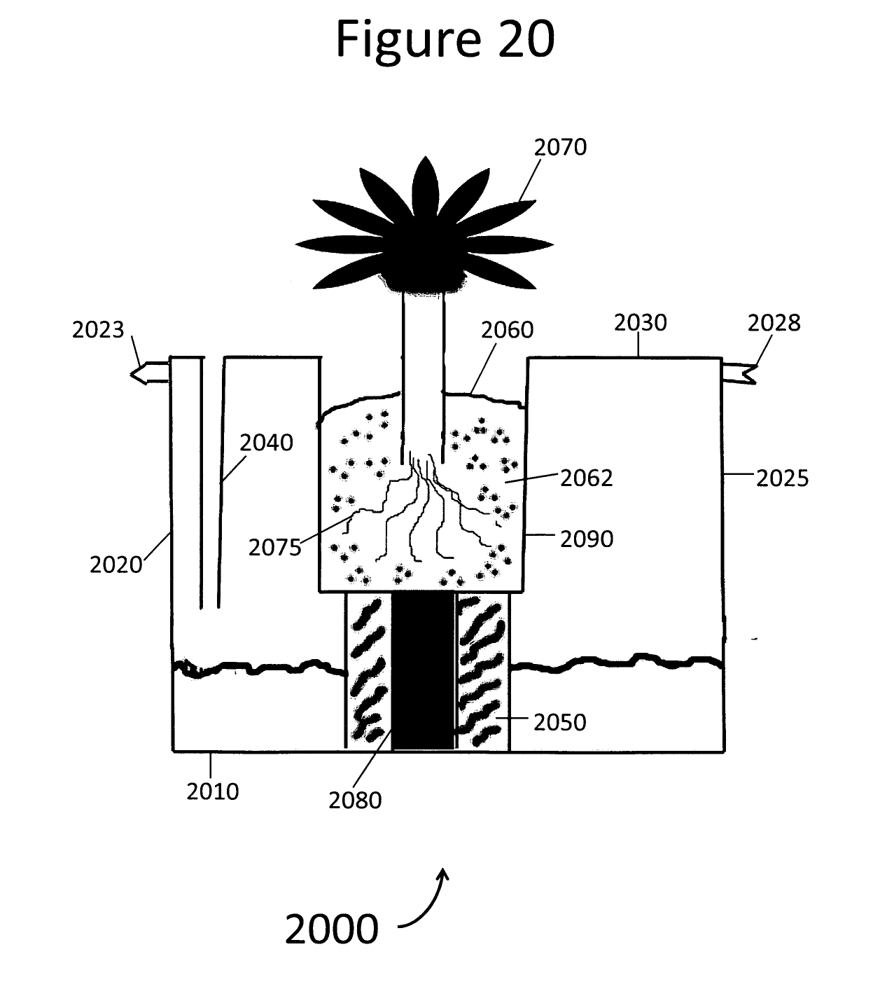

FIG. 20 illustrates a modular apparatus for an irrigation system 2000 according to an embodiment of the present invention. The modular apparatus for an irrigation system 2000 includes a base floor 2010, a left side wall 2020, a right side wall 2025, a connecting clasp 2023, a receiving clasp 2028, a top surface 2030, a water channel 2040, a wick 2050, a nutrient bag 2060, nutrient 2062, a plant 2070, plant roots 2075, a nutrient bag stand 2080, and a nutrient bag cup 2090.

The base floor 2010 is adjoined to left side wall 2020 along its left edge and is adjoined to right side wall 2025 along its right edge. A connecting clasp 2023 is affixed to the left side wall 2020. A receiving clasp 2028 is affixed to the right side wall 2025. The top surface 2030 intersects with the left side wall 2020 and the right side wall 2025. The base floor 2010, left side wall 2020, right side wall 2025, and top surface 2030 form a water retention chamber, within which water may be stored. The receiving end of the water channel 2040 is located on the top surface 2030. The water channel 2040 extends down towards the base floor 2010. The delivering end of the water channel 2040 is located slightly above the base floor 2010. The wick 2050 rests on the base floor 2010. The wick 2050 extends vertically from the base floor 2010 into the nutrient bag 2060 through an opening in the nutrient bag cup 2090. The nutrient bag 2060 rests within the nutrient bag cup 2090. The roots 2075 of the plant 2070 are encased in the nutrient bag 2060. The trunk of the plant 2070 extends vertically from within the nutrient bag 2060 through an aperture in the top surface 2030. The vegetation of the plant 2070 is situated above the top surface 2030. The nutrient bag stand 2080 rests on the base floor 2010. The nutrient bag cup 2090 rests on the nutrient bag stand 2080. The nutrient bag cup 2090 extends vertically through an aperture in the top surface 2030.

The vegetation of the plant 2070 receives light from an external light source such as the sun. The vegetation of the plant 2070 is also visible to observers of the modular apparatus for an irrigation system 2000. Water from an external source such as the atmosphere descends onto the top surface 2030 and the vegetation of the plant 2070. The top surface 2030 is impermeable. The water rests on the top surface 2030 and flows down the water channel 2040. The water exits the water channel 2040 and collects on the base floor 2010. The wick 2050 absorbs water that has collected on the base floor 2010. The wick 2050 continues to absorb water from the base floor 2010 until the wick 2050 is saturated. The water within the wick 2050 travels upwards along the wick 2050 until it reaches the interface between the top end of the wick 2050 and the nutrient 2062. The nutrient 2062 absorbs water from the wick 2050. The water percolates through the nutrient 2062 and reaches the interface between the roots 2075 and the nutrient 2062. The roots 2075 then absorb water from the nutrient 2062. The modular apparatus for an irrigation system 2000 thus houses a plant that is nourished with light, nutrient, and water. Water and nutrient are provided to the plant through sub-irrigation and wicking technology.

In an embodiment of the present invention, there is a plurality of apertures on the top surface 2030. Nutrient bag cups 2090 housing plants 2070 may be placed through each of these apertures. In an alternative embodiment of the present invention, the water may travel down towards the base floor 2010 via a water pipe rather than the water channel 2040. In this embodiment, the receiving end of the water pipe is located where the receiving end of the water channel 2040 is ordinarily situated. Alternatively, there may be neither a water channel 2040 nor a water pipe. The water enters an aperture located on the top surface 2030 where the receiving end of the water channel 2040 is ordinarily situated. The water then drops directly onto the base floor 2010.

The connecting clasp 2023 may connect with the receiving clasp 2028 of a second modular apparatus for an irrigation system 2000. Several modular apparatuses for an irrigation system 2000 may be connected together in this way.

In one embodiment of the modular apparatus for an irrigation system 2000, the left side wall 2020 and right side wall 2025 are made of plastic. Alternatively, the left side wall 2020 and right side wall 2025 may be made of a biodegradable material. The nutrient 2062 is preferably soil. The nutrient 2062 may also contain fertilizer. The water channel 2040 may be made of various materials such as plastic or steel. The plant 2070 may be a small tree, bush, or vegetable. The top surface 2030 may be constructed so that it is parallel to the surface on which the modular apparatus for an irrigation system 2000 rests. Alternatively, the top surface 2030 may be slanted relative to the resting surface so that water on the top surface 2030 travels more quickly to the opening of the water channel 2040. In an alternative embodiment of the present invention, the top of the nutrient bag cup 2090 may include a lip along its perimeter. The lip rests on the top surface 2030. The nutrient bag cup 2090 is thereby held aloft and the nutrient bag stand 2080 is no longer needed.

In an alternative embodiment of the present invention, there is a plurality of wicks 2050. There may also be a plurality of water channels 2040 through which water may travel to the water retention chamber. The base floor 2010, left side wall 2020, right side wall 2025, and top surface 2030 may be adjoined so as to form a cube. Alternatively, the base floor 2010, left side wall 2020, right side wall 2025, and top surface 2030 may form a three-dimensional rectangle, trapezoid or other shape. The base floor 2010, left side wall 2020, right side wall 2025, and top surface 2030 may also be curved so that the modular apparatus 2000 is spherical.

The use of the connecting clasp 2023 and the receiving clasp 2028 to interconnect modular apparatuses for an irrigation system 2000 may be replaced by various alternative connecting mechanisms. For example, the left side wall 2020 and right side wall 2025 may feature grooves along their surfaces that allow modules to fit together. Alternatively, the left side wall 2020 and right side wall 2025 may contain lips along their edges that would enable the modules to hook together.

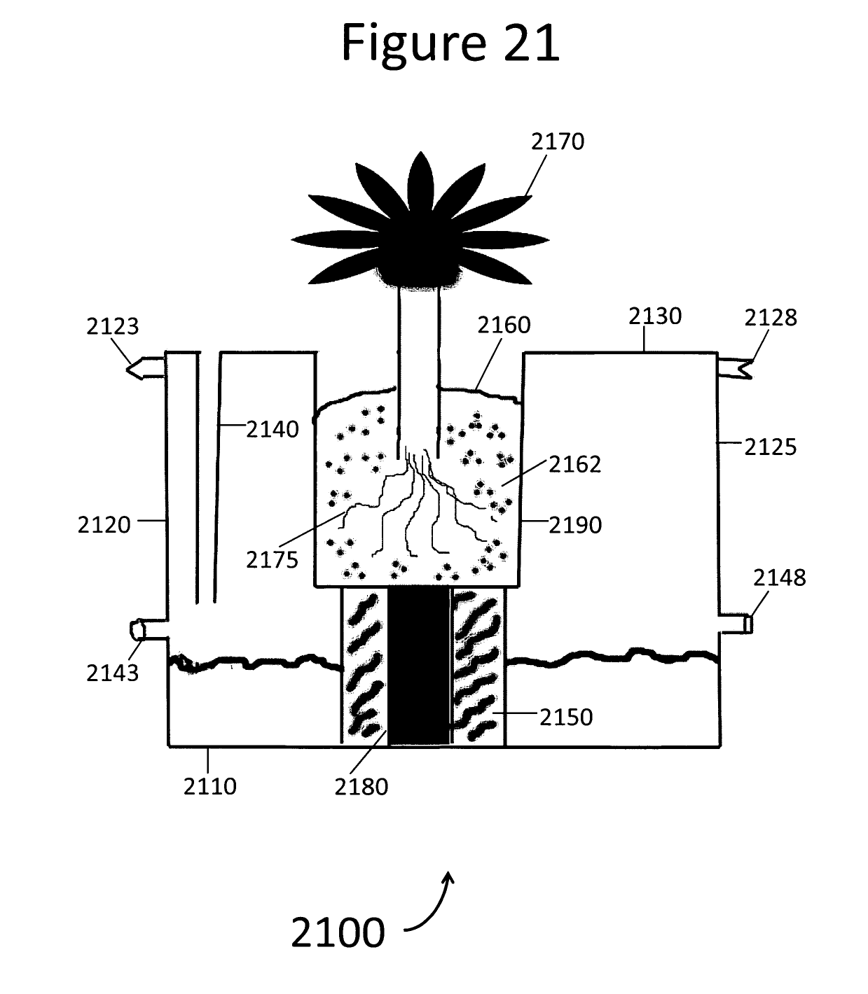

FIG. 21 illustrates a modular apparatus for an irrigation system 2100 according to an embodiment of the present invention. The modular apparatus for an irrigation system 2100 includes a base floor 2110, a left side wall 2120, a right side wall 2125, a connecting clasp 2123, a receiving clasp 2128, a top surface 2130, a water channel 2140, a left exit pipe 2143, a right exit pipe 2148, a wick 2150, a nutrient bag 2160, nutrient 2162, a plant 2170, plant roots 2175, a nutrient bag stand 2180, and a nutrient bag cup 2190.

The base floor 2110 is adjoined to left side wall 2120 along its left edge and is adjoined to right side wall 2125 along its right edge. A connecting clasp 2123 is affixed to the left side wall 2120. A receiving clasp 2128 is affixed to the right side wall 2125. The top surface 2130 intersects with the left side wall 2120 and the right side wall 2125. The base floor 2110, left side wall 2120, right side wall 2125, and top surface 2130 form a water retention chamber, within which water may be stored. The receiving end of the water channel 2140 is located on the top surface 2130. The water channel 2140 extends down towards the base floor 2110. The delivering end of the water channel 2140 is located slightly above the base floor 2110. The wick 2150 rests on the base floor 2110. The wick 2150 extends vertically from the base floor 2110 into the nutrient bag 2160 through an opening in the nutrient bag cup 2190. The nutrient bag 2160 rests within the nutrient bag cup 2190. The roots 2175 of the plant 2170 are encased in the nutrient bag 2160. The trunk of the plant 2170 extends vertically from within the nutrient bag 2160 through an aperture in the top surface 2130. The vegetation of the plant 2170 is situated above the top surface 2130. The nutrient bag stand 2180 rests on the base floor 2110. The nutrient bag cup 2190 rests on the nutrient bag stand 2180 and extends vertically though an aperture in the top surface 2130. The left exit pipe 2143 extends perpendicular to the left side wall 2120 and originates at an aperture in the left side wall 2120. The right exit pipe 2148 extends perpendicular to the right side wall 2125 and originates at an aperture in the right side wall 2125.

The vegetation of the plant 2170 receives light from an external light source such as the sun. The vegetation of the plant 2170 is also visible to observers of the modular apparatus for an irrigation system 2100. Water from an external source such as the atmosphere descends onto the top surface 2130 and the vegetation of the plant 2170. The top surface 2130 is impermeable. The water rests on the top surface 2130 and flows down the water channel 2140. The water exits the water channel 2140 and collects on the base floor 2110. The water level within the water retention chamber eventually reaches the height where the left exit pipe 2143 and the right exit pipe 2148 are located. The water then flows out of the water retention chamber through the left exit pipe 2143 and the right exit pipe 2148. The water may then flow into adjacent modules. The water level within the water retention chamber thereby never exceeds the height at which the left exit pipe 2143 and right exit pipe 2148 are located.

The wick 2150 absorbs water that has collected on the base floor 2110. The wick 2150 continues to absorb water from the base floor 2110 until the wick 2150 is saturated. The water within the wick 2150 travels upwards along the wick 2150 until it reaches the interface between the top end of the wick 2150 and the nutrient 2162. The nutrient 2162 absorbs water from the wick 2150. The water percolates through the nutrient 2162 and reaches the interface between the roots 2175 and the nutrient 2162. The roots 2175 then absorb water from the nutrient 2162. The modular apparatus for an irrigation system 2100 thus houses a plant that is nourished with light, nutrient, and water. Water and nutrient are provided to the plant through sub-irrigation and wicking technology.

In an embodiment of the present invention, there is a plurality of apertures on the top surface 2130. Nutrient bag cups 2090 housing plants 2170 may be placed through each of these apertures. In an alternative embodiment of the present invention, the water may travel down towards the base floor 2110 via a water pipe rather than the water channel 2140. In this embodiment, the receiving end of the water pipe is located where the receiving end of the water channel 2140 is ordinarily situated. The delivering end of the water pipe is located where the delivering end of the water channel 2140 is located. Alternatively, there may be neither a water channel 2140 nor a water pipe. The water enters an aperture located on the top surface 2130 where the receiving end of the water channel 2140 is ordinarily situated. The water then drops directly onto the base floor 2110.

The connecting clasp 2123 may connect with the receiving clasp 2128 of a second modular apparatus for an irrigation system 2100. Several modular apparatuses for an irrigation system 2100 may be connected together in this way.

In one embodiment of the modular apparatus for an irrigation system 2100, the left side wall 2120 and right side wall 2125 are made of plastic. Alternatively, the left side wall 2120 and right side wall 2125 may be made of a biodegradable material. The nutrient 2162 is preferably soil. The nutrient 2162 may also contain fertilizer. The water channel 2140 may be made of various materials such as plastic or steel. The plant 2170 may be a small tree, bush, or vegetable. The top surface 2130 may be constructed so that it is parallel to the surface on which the modular apparatus for an irrigation system 2100 rests. Alternatively, the top surface 2130 may be slanted relative to the resting surface so that water on the top surface 2130 travels more quickly to the opening of the water channel 2140.

In an alternative embodiment of the present invention, the top of the nutrient bag cup 2190 may include a lip along its perimeter. The lip rests on the top surface 2130. The nutrient bag cup 2190 is thereby held aloft and the nutrient bag stand 2180 is no longer needed. In an alternative embodiment of the present invention, there is neither a left exit pipe 2143 nor a right exit pipe 2148. Rather, there are apertures where the pipes are ordinarily located. Water then flows down the exterior of the side walls 2120 and 2125 rather than through exit pipes.

In an alternative embodiment of the present invention, there is a plurality of wicks 2150. There may also be a plurality of water channels 2140 through which water may travel to the water retention chamber. The base floor 2110, left side wall 2120, right side wall 2125, and top surface 2130 may be adjoined so as to form a cube. Alternatively, the base floor 2110, left side wall 2120, right side wall 2125, and top surface 2130 may form a three-dimensional rectangle, trapezoid or other shape. The base floor 2110, left side wall 2120, right side wall 2125, and top surface 2130 may also be curved so that the modular apparatus 2100 is spherical.

The use of the connecting clasp 2123 and the receiving clasp 2128 to interconnect modular apparatuses for an irrigation system 2100 may be replaced by various alternative connecting mechanisms. For example, the left side wall 2120 and right side wall 2125 may feature grooves along their surfaces that allow modules to fit together. Alternatively, the left side wall 2120 and right side wall 2125 may contain lips along their edges that would enable the modules to hook together.

The foregoing embodiments provide a modular apparatus that accommodate the sustenance of vegetation through sub-irrigation. The design of the modules prevents the leaching of nutrient that occurs when water runs straight down through soil. In the present invention, water travels upwards along a wick into the nutrient that houses the vegetation. The modules may be easily installed on outdoor surfaces such as roofs. The modules may be connected together to form an array. Once installed, the plants housed in the modules may be replaced year-round by, for example, hydroponic plants. The modules utilize a single layer of nutrient and so are lighter than typical structures used to grow vegetation. The modules may also be equipped with control systems to regulate the amount of water present within the modules. The water may be stored for later use or purged from the module to reduce the weight of the module.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A modular apparatus for an irrigation system comprising:
a. a water retention chamber, said water retention chamber comprising
i. a base floor;
ii. walls intersecting the edges of said base floor;
iii. a top surface intersecting said walls, wherein said top surface is impermeable;
b. a water pipe, said water pipe having a receiving end and a delivering end, wherein said receiving end receives water on said top surface and said delivering end delivers water onto the base floor.

2. The modular apparatus for an irrigation system as claimed in claim 1, wherein said water pipe further comprises a valve for control of water flow through said water pipe.

3. The modular apparatus for an irrigation system as claimed in claim 2, wherein said valve is in electronic communication with a controller, wherein said controller is in electronic communication with a sensor that determines the level of water above said base floor.

4. The modular apparatus for an irrigation system as claimed in claim 1, wherein said apparatus further comprises a top surface intersecting said walls, said top surface including an aperture through which a plant may be placed.

5. The modular apparatus for an irrigation system as claimed in claim 4, wherein said top surface further includes hooks to hold said plant attached to the interior of said aperture.

6. The modular apparatus for an irrigation system as claimed in claim 4, wherein the roots of said plant are encased in a bag of nutrient.

7. The modular apparatus for an irrigation system as claimed in claim 4, wherein said modular apparatus further comprises a wick attached to said base floor, said wick extending into said bag of nutrient.

8. The modular apparatus for an irrigation system as claimed in claim 7, wherein said wick transports water from said base floor to said bag of nutrient.

9. The modular apparatus for an irrigation system as claimed in claim 4, wherein said modular apparatus further comprises a tray above said base floor, said tray laying parallel to said base floor and intersecting said walls.

10. The modular apparatus for an irrigation system as claimed in claim 9, wherein said tray holds a layer of nutrient on its surface.

11. The modular apparatus for an irrigation system as claimed in claim 10, wherein said modular apparatus further comprises a wick attached to said base floor, said wick extending into said layer of nutrient.

12. The modular apparatus for an irrigation system as claimed in claim 1, wherein hooks are attached to said walls for the purpose of connecting said modules.

13. The modular apparatus for an irrigation system as claimed in claim 1, wherein said modules further comprise a layer of permeable material that rests over said base floor.

14. The modular apparatus for an irrigation system as claimed in claim 1, wherein said walls are made of a biodegradable material.

15. The modular apparatus for an irrigation system as claimed in claim 1, wherein said modular apparatus is placed on a roof.

16. A tray base for an irrigation system comprising
a. a base floor containing as part of its mold a plurality of vertical protrusions, said vertical protrusions housing a wicking material and having an aperture at its surface through which a plant's roots may be placed;
b. walls intersecting the edges of said base floor;
c. a top surface intersecting said walls, wherein said top surface is impermeable and includes a plurality of apertures through which plants may be placed;
d. a water pipe, said water pipe having a receiving end and a delivering end, wherein said receiving end receives water on said top surface and said delivering end delivers water onto the base floor.

17. A tray base for an irrigation system as claimed in claim 16, wherein said water pipe further comprises a valve for control of water flow through said water pipe.

18. A tray base for an irrigation system as claimed in claim 17, wherein said valve is in electronic communication with a controller, and said controller is in electronic communication with a sensor that determines the level of water above said base floor.

19. A tray base for an irrigation system as claimed in claim 16, wherein said apertures on said top surface are located directly above said vertical protrusions.

20. A tray base for an irrigation system as claimed in claim 16, wherein said tray base further comprises a layer of permeable material that rests over said base floor.

21. A tray base for an irrigation system as claimed in claim 16, wherein said walls are made of a biodegradable material.

22. A tray base for an irrigation system as claimed in claim 16, wherein said vertical protrusions are spaced evenly in an array.

23. The tray base for an irrigation system as claimed in claim 16, wherein said vertical protrusions are spaced within three inches of each other.

24. The tray base for an irrigation system as claimed in claim 20, wherein said vertical protrusions are spaced within three inches of each other.

25. A method for maintaining a roof irrigation system, said method comprising:
a. installing a modular apparatus, said modular apparatus including
i. a water retention chamber, said water retention chamber comprising
1. a base floor;
2. walls intersecting the edges of said base floor;
3. a top surface intersecting said walls, wherein said top surface is impermeable;
ii. a water pipe, said water pipe having a receiving end and a delivering end, wherein said receiving end is located on said top surface and said delivering end delivers water onto the base floor.
b. removing an undesired plant from an individual module; and
c. placing a new plant in said individual module that formerly housed said undesired plant.

26. A method for maintaining a roof irrigation system as claimed in claim 25, wherein said new plants are hydroponically-grown plants.

27. The method for maintaining a roof irrigation system as claimed in claim 25, wherein said new plants are vegetables.

28. The method for maintaining a roof irrigation system as claimed in claim 25, wherein said new plants have been grown in a greenhouse.

29. The method for maintaining a roof irrigation system as claimed in claim 25, wherein said removal step and said replacement step may occur at any time of the year without diminishing the overall health of said roof irrigation system.

30. The method for maintaining a roof irrigation system as claimed in claim 25, wherein said method further comprises a module removal step wherein one or more of the modules within the modular apparatus is removed.

31. The method for maintaining a roof irrigation system as claimed in claim 25, wherein said method further comprises a module addition step wherein one or more modules is added to the existing modular apparatus.

32. A method for installing a roof irrigation system, said method comprising:
a. assessing the load-bearing capacity of the roof;
b. designing modules for an irrigation system in conformance with said load-bearing capacity and client needs;
c. laying out said modules in an array along the surface of the roof; and
d. inserting plants into said modules.

33. The method for installing a roof irrigation system as claimed in claim 32, wherein said plants are hydroponic plants.

34. The method for installing a roof irrigation system as claimed in claim 32, wherein said plants are vegetables.
